(19) United States
(12) Patent Application Publication
(10) Pub. No.: US 2012/0291349 A1
(43) Pub. Date: Nov. 22, 2012

(54) PLANTING THREE-DIMENSIONAL TEXTILE AND PLANTING APPARATUS USING THE SAME

(75) Inventors: Yung-Shun Teng, New Taipei City (TW); Li-Yun Chang, New Taipei City (TW); Reng-Sho Chen, New Taipei City (TW); Yang-Ping Shih, New Taipei City (TW); Ching-Luh Wang, New Taipei City (TW)

(73) Assignee: TAIWAN TEXTILE RESEARCH INSTITUTE, New Taipei City (TW)

(21) Appl. No.: 13/472,508

(22) Filed: May 16, 2012

(30) Foreign Application Priority Data
May 16, 2011 (TW) 100117039
Aug. 5, 2011 (TW) 100127943
Jan. 12, 2012 (TW) 101200766
Apr. 24, 2012 (TW) 101207646

(51) Int. Cl. A01G 9/02; A01G 25/00

(52) U.S. Cl. 47/65.7

(57) ABSTRACT

A planting three-dimensional textile including a first textile layer and a second textile layer is provided. The first textile layer has a plurality of connecting blocks which are separated from each other and arranged in array. The second textile layer covers the first textile layer, and the second textile layer is only connected to the connecting blocks so as to define a plurality of planting channels separated form each other between the first textile layer and the second textile layer. The second textile layer has a plurality of openings. A planting apparatus is also provided.

### CROSS-REFERENCE TO RELATED APPLICATION

This application claims the priority benefit of Taiwan application serial no. 100117039, filed on May 16, 2011, Taiwan application serial no. 100127943, filed on Aug. 5, 2011, Taiwan application serial no. 101200766, filed on Jan. 12, 2012, and Taiwan application serial no. 101207646, filed on Apr. 24, 2012. The entirety of each of the above-mentioned patent applications is hereby incorporated by reference herein and made a part of this specification.

### BACKGROUND OF THE INVENTION

1. Field of the Invention

The present invention relates to a planting three dimensional textile and a planting apparatus using the same.

2. Description of Related Art

Three dimensional planting is one of the developing green technology in recent years. Generally speaking, the three dimensional planting means the planting space is three-dimensional and can effectively covers the buildings or has an effect of beautifying the gardens, also meet the purpose of power saving and carbon reducing. Furthermore, three dimensional planting can also be modified to be applied to all kinds of outdoor environment. At the same time, three dimensional planting can be applied with different types and different colors of plantings so as to improve the overall appearance and the visual effect.

### SUMMARY OF THE INVENTION

The present invention is directed to a planting three-dimensional textile having light, thin, flexible and robust usable area and improving the green environment.

The present invention is further directed to a planting apparatus which is easy and convenient to be disassembled and assembled, also having better mobility.

One embodiment of the present invention provides a planting three-dimensional textile including a first textile layer and a second textile layer. The first textile layer has a first surface and a second surface. The first textile layer has a plurality of first connecting blocks which are separated from each other and arranged in array. The second textile layer covers the first surface. The second textile layer is only connected to the first connecting blocks so as to define a plurality of planting channels separated form each other between the first textile layer and the second textile layer. The second textile layer has a plurality of openings.

One embodiment of the present invention further provides a planting apparatus including a movable tank, a plurality of vertical brackets, at least one horizontal bracket, at least one three-dimensional textile, a top bracket and a watering device. The movable tank has a water collecting area and a supporting area surrounding the water collecting area. The vertical brackets stand on the supporting area. The horizontal bracket connects the vertical brackets. The three-dimensional textile is assembled on the horizontal bracket and covers the vertical brackets, and the three-dimensional textile is suitable for carrying plants. The top bracket is assembled on the top of the vertical brackets, the top bracket has a plurality of outlets facing toward the three-dimensional textile. The watering device has at least one channel. The channel is configured along at least one of the vertical brackets, and extended to at least one of the outlets of the top bracket.

The present invention further provides a planting apparatus including a three-dimensional textile, a pipe assembly and a cycling water supply unit. The three-dimensional textile has a plurality of planting channels. The pipe assembly is configured along the edge of the three-dimensional textile. The pipe assembly surrounds the planting channels. The cycling water supply unit is connected to the pipe assembly. The cycling water supply unit is configured to provide and transmit the water to the planting channels through the pipe assembly.

The present invention further provides a planting apparatus including a plurality of three-dimensional textiles, a plurality of connecting members, a pipe assembly and a cycling water supply unit. The three-dimensional textiles are connected to each other and have a plurality of planting channels separated from each other. Each of the connecting members connects the joint between each of the three-dimensional textiles for sealing the three-dimensional textiles. The pipe assembly is configured along the edge of the three-dimensional textiles, and the pipe assembly surrounds the planting channels. The cycling water supply unit is connected to the pipe assembly. The cycling water supply unit is configured to provide and transmit the water to the planting channels through the pipe assembly.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 illustrates a top view of a planting three-dimensional textile according to one embodiment of the present invention.

FIG. 2 illustrates a top view of a planting three-dimensional textile of FIG. 1 when subjected to an outer force.

FIG. 3 illustrates a perspective view of the planting three-dimensional textile of FIG. 2 fixed to a carrier.

FIG. 4 illustrates a top view of a planting three-dimensional textile subjected an outer force according to another embodiment of the present invention.

FIG. 5 illustrates a top view of a planting three-dimensional textile subjected an outer force according to another embodiment of the present invention.

FIG. 6 is a cross-sectional view of the connecting blocks in strip shape along line A-A′ in FIG. 2.

FIG. 7A illustrates a top view of a planting three-dimensional textile according to another embodiment of the present invention.

FIG. 7B is a schematic cross-sectional view of the planting three-dimensional textile along the line B-B′ of FIG. 7A.

FIG. 8 illustrates a top view of a planting three-dimensional textile according to another embodiment of the present invention.

FIG. 9 illustrates a schematic view of a planting three-dimensional textile according to an embodiment of the present invention.

FIG. 10A illustrates a schematic view of two planting three-dimensional textile connected to each other with the connecting member.

FIG. 10B illustrates a perspective view of the region C in FIG. 10A.

FIG. 11 is a schematic view of a planting apparatus according to one embodiment of the present invention.

FIG. 12A and FIG. 12B are exploded views of planting apparatus of FIG. 11, respectively.

FIG. 13A and FIG. 13B are side views showing the movable tank of FIG. 12A, respectively.

FIG. 14 to FIG. 16 are schematic views of a planting apparatus according to other embodiments of the present invention, respectively.

FIG. 17 is a schematic view of a planting apparatus according to another embodiment of the present invention.

FIG. 18 is a schematic view of the water cycling of the planting apparatus in FIG. 17.

FIG. 19 is a schematic view of a planting apparatus according to another embodiment of the present invention.

FIG. 20 is a cross-sectional view of the planting three-dimensional textile taken along line C-C in FIG. 19.

FIG. 21 is a schematic view of a planting apparatus according to another embodiment of the present invention.

FIG. 22 is a schematic perspective view of the planting apparatus of FIG. 21.

FIG. 23 and FIG. 24 are schematic assembled views of a planting apparatus according to another embodiment of the present invention.

FIG. 25 and FIG. 26 are schematic assembled views of a planting apparatus according to another embodiment of the present invention.

FIG. 27 is a schematic view of a planting apparatus according to another embodiment of the present invention.

### DESCRIPTION OF EMBODIMENTS

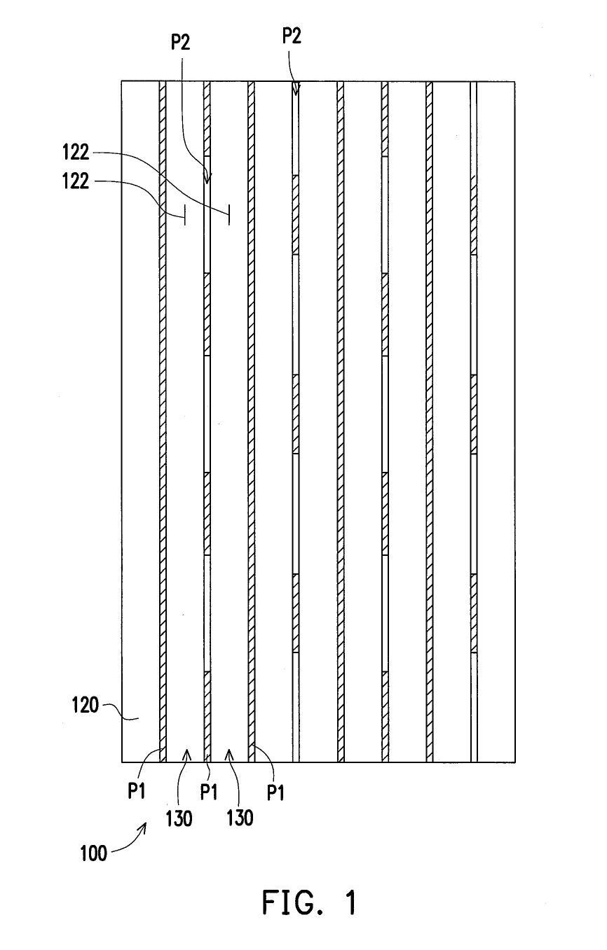

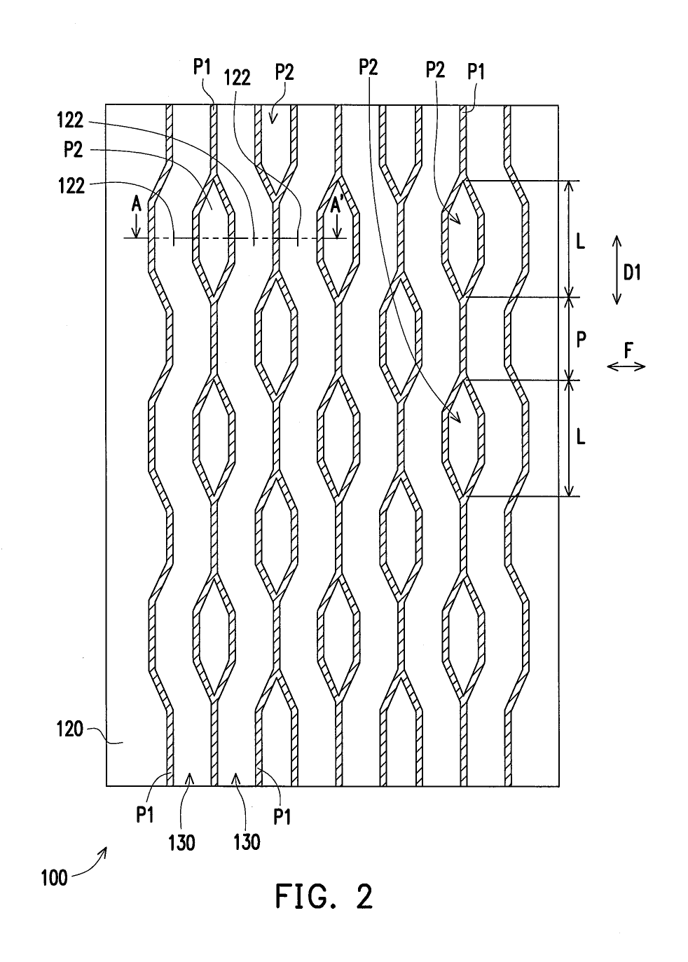

FIG. 1 illustrates a top view of a planting three-dimensional textile according to one embodiment of the present invention. FIG. 2 illustrates a top view of a planting three-dimensional textile of FIG. 1 when subjected to an outer force. Referring to FIG. 1 and FIG. 2, in the present embodiment, the planting three-dimensional textile 100 includes at least two textile layers, and the textile layers are partially connected to each other. It is noted that the textile layers are overlapped with each other, therefore, due to the view angle of FIG. 1 and FIG. 2, only the textile layer 120 located at the top can be seen. As shown in FIG. 1 and FIG. 2, the planting three-dimensional textile 100 has a plurality of connecting blocks P1 and a plurality of planting channels 130 which are separated with and substantially parallel to each other. The connecting blocks P1 and the planting channels 130 are in strip shape, wherein the planting channels 130 are formed between two adjacent textile layers. Moreover, each of the connecting blocks P1 has a plurality of cutting apertures P2 separated from each other, the extending direction of the cutting apertures P2 are substantially formed on the connecting blocks P1, and the cutting apertures P2 pass through the textile layers.

In detail, the extending direction of each cutting aperture P2 is parallel to a direction D1, and the direction D1 is, for example, the extending direction of the connecting blocks P1 of FIG. 1. When the planting three-dimensional textile 100 is subjected to an outer force F along a vertical direction D1, the width of each cutting aperture is forced to be magnified such that the planting channels 130 are presented in mesh pattern, as shown in FIG. 2. In the present embodiment, the cutting apertures P2 is formed on the textile layers by, for example, fusing, mechanical cutting or laser cutting, etc.

Thus, when a user applies the outer force F onto the planting three-dimensional textile 100, two ends of each cutting aperture P2 are confined by the corresponding connecting blocks P1 so as to force the widths of the cutting apertures P2 to be magnified along the direction substantially parallel to the outer force F. Therefore, each cutting aperture P2 is expanded toward the two sides of each cutting aperture P2. Furthermore, because the cutting apertures P2 are alternately arranged, after each cutting aperture P2 is expanded, the planting channels 130 are presented in mesh pattern due to the stretching of the textile layer, such that the cover area of the planting three-dimensional textile 100 is magnified. Thus, the planting three-dimensional textile 100 can arbitrarily change the area to be covered according to different degree of stretching, so as to broaden the application of the planting three-dimensional textile 100.

Referring to FIG. 2, in the present embodiment, the length of each cutting aperture P2 is L, the gap between any two adjoining cutting apertures P2 located within the same connecting block P1 is P, and the length L is generally required to be greater than the gap P. Thereby, when the user applies an outer force F to the planting three-dimensional textile 100, less strength is required to expand the planting three-dimensional textile 100, so the user can perform the subsequent operation easily. Moreover, after the planting three-dimensional textile 100 is fully expanded, the usable area of the planting three-dimensional textile 100 can be maximized. Each of the connecting blocks P1 has a plurality of cutting apertures P2 which are separated with and parallel to each other, so the cover area of the planting three-dimensional textile 100 is highly flexible. Different forms of planting three-dimensional textiles are illustrated in detail hereinafter.

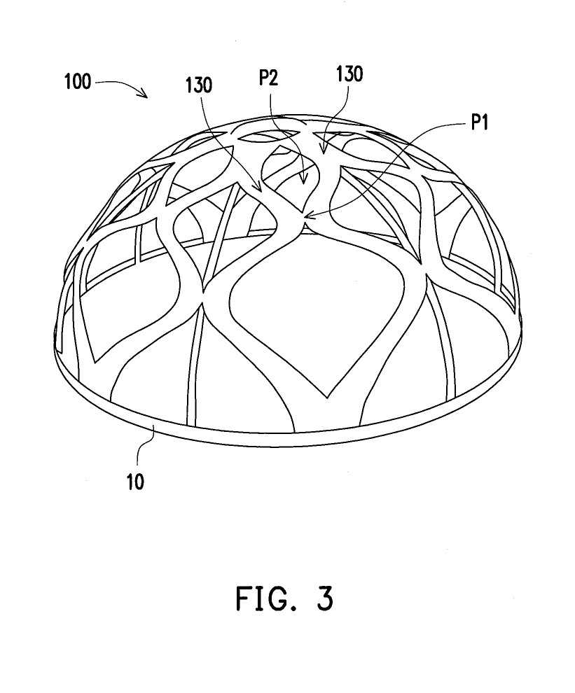

FIG. 3 illustrates a perspective view of the planting three-dimensional textile of FIG. 2 fixed to a carrier. Referring to FIG. 3, after the planting three-dimensional textile 100 is expanded, the expanded planting three-dimensional textile 100 can be fixed to a carrier 10, the carrier 10 is, for example, about a hemispherical frame, at the time, the planting channels 130 of the planting three-dimensional 100 are d in mesh pattern.

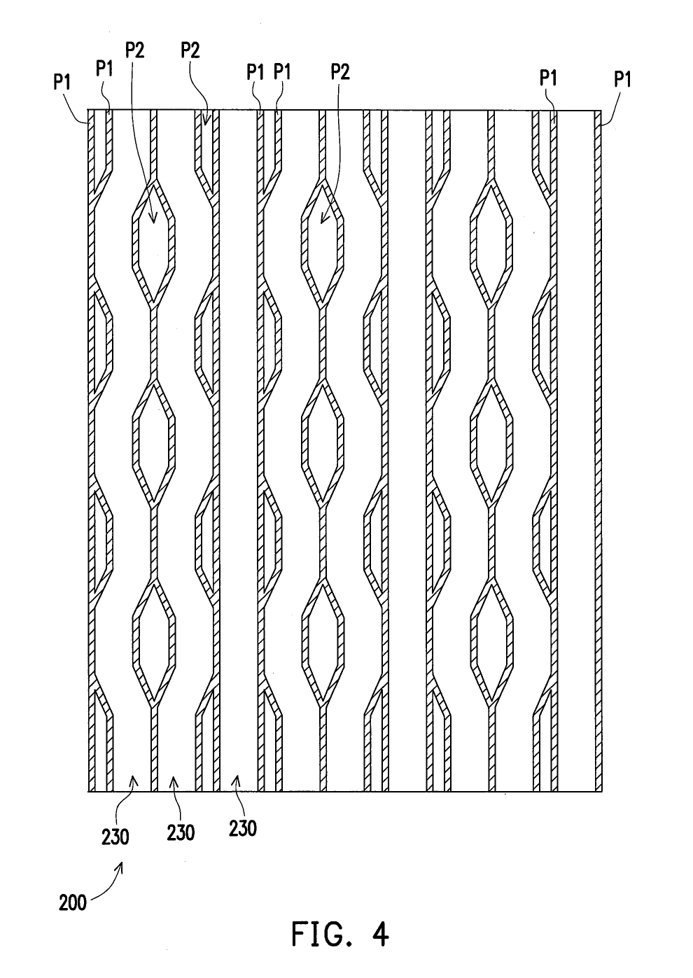

FIG. 4 illustrates a top view of a planting three-dimensional textile subjected an outer force according to another embodiment of the present invention. Referring to FIG. 2 and FIG. 4, the planting three-dimensional textile 200 of the present embodiment, as shown in FIG. 4, is similar to the planting three-dimensional textile 100, as shown in FIG. 2. The main difference between the two planting three-dimensional textiles 200, 100 is, in the present embodiment, part of the cutting apertures P2 of the planting three-dimensional textile 200 are in hexagonal shape, and part of the cutting apertures P2 are in trapezoid shape. Thereby, after the planting three dimensional textile 200 is expanded, the planting channels 230 are presented in different mesh pattern so as to be applied to special shape according to the occasions.

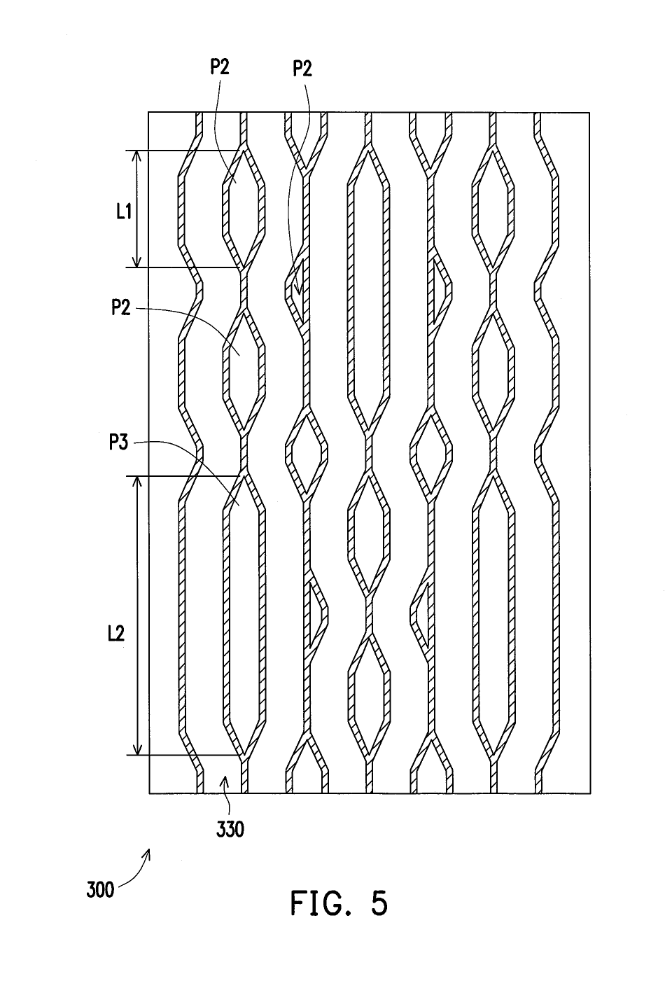

FIG. 5 illustrates a top view of a planting three-dimensional textile subjected an outer force according to another embodiment of the present invention. Referring to FIG. 2 and FIG. 5, the planting three-dimensional textile 300 of the present embodiment, as shown in FIG. 5, is similar to the planting three-dimensional textile 100, as shown in FIG. 2. The main difference between the two planting three-dimensional textiles 300, 100 is, in the present embodiment, the lengths of a part of the cutting apertures P2 of the planting three-dimensional textile 300 are L1, and the lengths of a part of the cutting apertures P3 are L2, and the lengths L1 are substantially not equal to the length L2. Therefore, when the user applies the outer force F to the planting three-dimensional textile 300, the planting channels 330 are presented in the pattern with various sizes of meshes. Thereby, the planting three-dimensional textile 300 can be applied to the carrier with special profile, not shown. Moreover, as shown in FIG. 5, part of the cutting apertures P2 are in hexagonal shape and part of the cutting apertures P2 are in trapezoid shape, such that the planting channels 330 after being expanded can be applied to special shape according to the occasions.

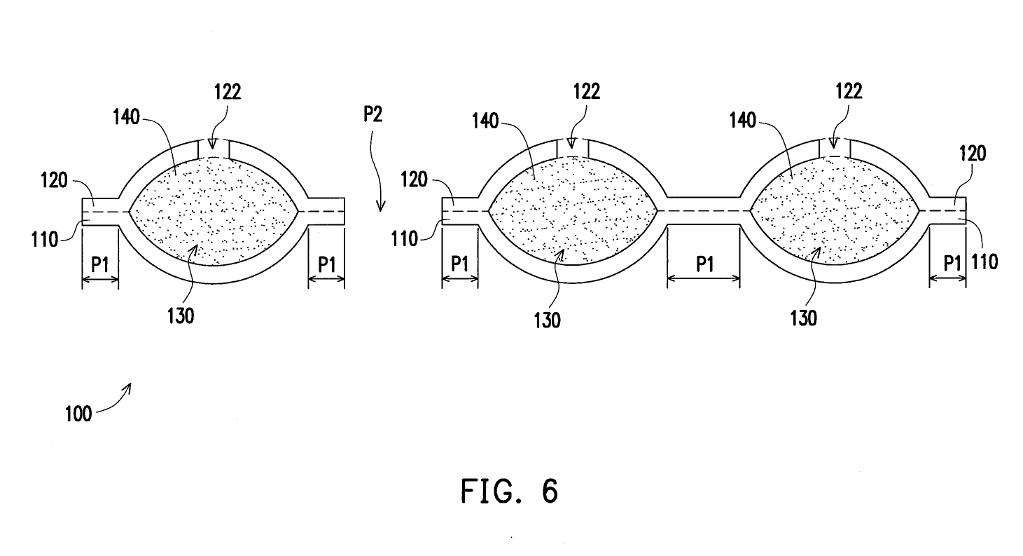

FIG. 6 is a cross-sectional view of the connecting blocks in strip shape along line A-A′ in FIG. 2. Referring to FIG. 2 and FIG. 6, for example, the planting three-dimensional textile 100 includes two textile layers 110 and 120 which are stacked against each other. In the present embodiment, the textile layers 120 covers the textile layer 110, and the portion where the textile layer 110 and the textile layer 120 are connected to each other is the above-mentioned connecting blocks P1, and the portion where the textile layer 110 and the textile layer 120 are not connected to each other can form the above-mentioned planting channels 130. In other words, the textile layers 110, 120 are only connected to each other by the connecting blocks P1 to define the plurality of planting channels 130 separated from each other between the textile layer 110 and the textile layer 120.

Furthermore, the textile layer 120 has a plurality of openings 122 for plants (not shown) to grow out from. Thereby, the plants can grow out from the openings 122. The openings 122 of the present embodiment is formed on the textile layer 120 by, for example fusing, mechanical cutting or laser cutting, etc. The distributing density and the size of the openings 122 depend on the planting requirement, which the present embodiment is not limited thereto. It is noted that, apart from forming the opening 122 on the textile layer 120, the present embodiment can also selectively formed similar openings on the textile layer 110, not shown.

On the other hand, the planting three-dimensional textile 100 can further include a plurality of planting fillings 140, the planting fillings 140 are filled in the planting channels 130, and the openings 122 expose part of the planting fillings 140. In other words, the user can plant the seeds of the plants (not shown) or the plants in the planting fillings 140 of the planting channels 130. When the seeds of the plants or plants sprout and grow, the plants can grow up from the openings 122. The planting fillers 140 of the present embodiment include natural fibers, regenerated fibers, semi-regenerated fibers, synthetic fibers, semi-synthetic fibers, paper pulp, foam, soil-free planting substrate, planting soil, acetate fibers or tri-acetate fibers Therefore, after water is provided into the planting channels 130, the plants in the planting fillings 140 can absorb the water and grow up. Furthermore, the water is easily held in the planting fillings 140 because the planting channels 130 are not connected to each other through the cutting apertures P2.

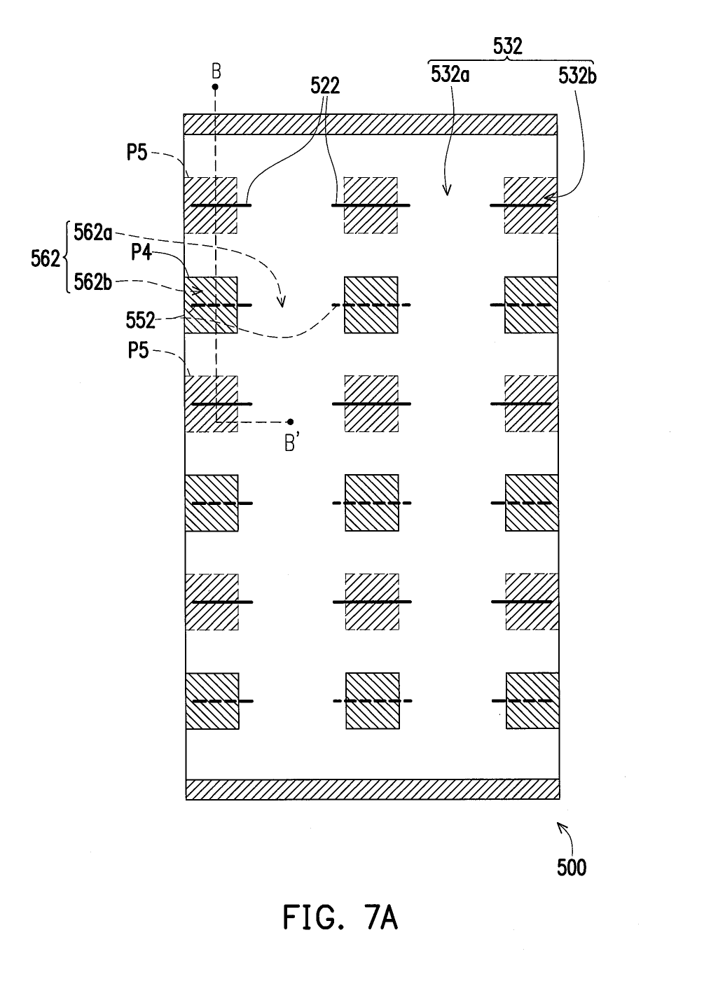

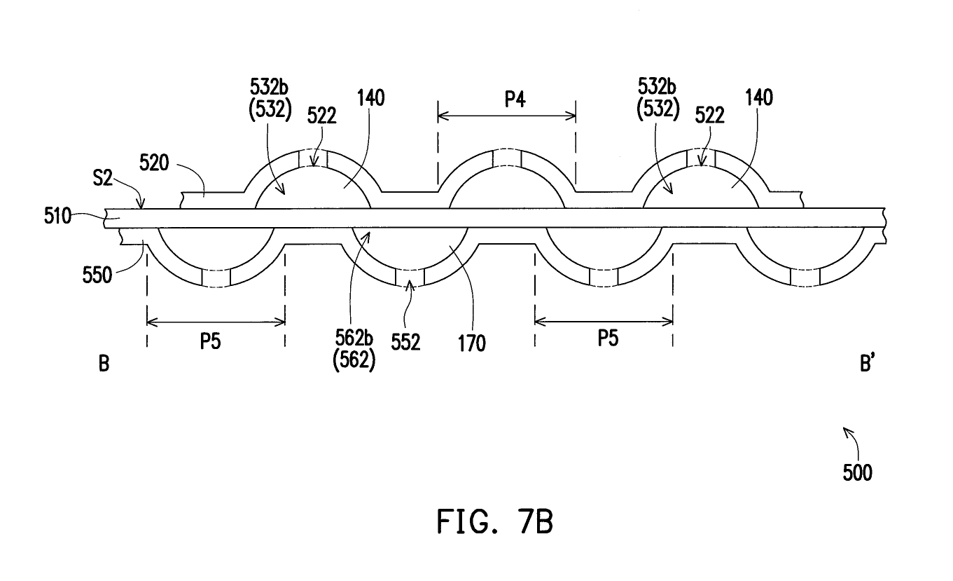

FIG. 7A illustrates a top view of a planting three-dimensional textile according another embodiment of the present invention, and FIG. 7B illustrates a cross-sectional view of the planting three-dimensional textile along the line B-B′ in FIG. 7A. Referring to both FIG. 7A and FIG. 7B, the planting three-dimensional textile 500 similar to the above-mentioned embodiments also includes textile layers 510, 520, wherein the textile layer 510 has a surface S1 and a surface S2 which are opposite to each other, and the textile layer 520 covers the surface S1. Herein, the textile layers 510, 520 are connected to each other by a plurality of connecting blocks P4 which are separated from each other and arranged in array, so as to define a plurality of planting channels 532 between the textile layers 510, 520. The planting fillers 140 are filled in the planting channels 532, wherein the openings 522 expose part of the planting fillings 140.

The only difference is that the planting channels 532 connected to each other includes a plurality of vertical planting channels 532a and a plurality of horizontal planting channels 532b, and the vertical planting channels 532a and the horizontal planting channels 532b are interlaced with and connected to each other.

Moreover, the planting three-dimensional textile 500 further comprises a textile layer 550 covering the surface S2 of the textile layer 510, wherein the textile layers 510, 550 are connected to each other by a plurality of connecting blocks P5 which are separated from each other and arranged in array, so as to define a plurality of planting channels 562 between the textile layers 510, 550. In the present embodiment, the connecting blocks P4 and the connecting blocks P5 are not overlapped.

Additionally, the above-mentioned planting channels 562 connected to each other can further include a plurality of vertical planting channels 562a and a plurality of horizontal planting channels 562b, and the vertical planting channels 562a and the horizontal planting channels 532b are interlaced with and connected to each other. In the present embodiment, the planting channels 562 are illustrated with the vertical planting channels 562a and the horizontal planting channels 562b; in other embodiment, the planting channels 562 can also be presented in mesh pattern.

In the planting three-dimensional textile 500, the textile layers 510, 520 and 550 can be integrally woven by a loom with longitudinal yarns and latitudinal yarns interlaced and connected to each other. In another embodiment, the textile layers 510, 520 and 550 can be separately made, then, the part of the textile layers 510 and 520 located in the connecting blocks P4 are interlaced with each other by the loom, and the part of the textile layers 510 and 550 located in the connecting blocks P5 are interlaced with each other by the loom, wherein the textile layer 510 located between the textile layers 520 and 550. In other words, the planting three-dimensional textile 500 can be formed by pieced the textile layers 510, 520 and 550 together. However, in another embodiment, the textile layers 510, 520 (or textile layers 510, 550) can be integrally woven, and then the textile layer 550 (or textile layers 520) can be interlaced with and connected to the textile layer 510 in pocket form.

Referring to FIG. 7A and FIG. 7B, the textile layer 550 has a plurality of openings 552. In the present embodiment, the openings 552 expose the planting channels 562, and the openings 552 is mainly configured for the plants (not shown) in the planting channels 562 to grow up from. In detail, the planting three-dimensional textile 500 further includes a plurality of planting fillings 170, wherein the planting fillings 170 are filled in the planting channels 562, and the openings 552 expose part of the planting fillings 170. In other words, the user can plant the seeds of the plants (not shown) in the planting fillings 170 of the planting channels 562. When the seeds of the plants sprout and grow, the plants can grow up from the openings 552. Similarly, the planting filings 170 may adopt the materials of the above-described planting filings 140, and thus, detail descriptions are omitted.

In the above-mentioned embodiments, material of the textile layers can be polyester, polypropylene, polyolefin polymer, nylon, rayon or synthetic cotton fibers or any combination thereof. In addition, the textile layers can be made by the loom with longitudinal yarns and latitudinal yarns interlaced with each other. In detail, the weaving method of the textile layers can be single stitch with single thread or single stitch with double thread, and for improving the weaving strength of the textile layers, J seam (SSn) can also be adapted. The weaving strength thus can be increased at least twice or higher. Moreover, the material of the textile layers can be the same as or different from each other. The following Table 1 shows the test result of the textile layers of the present embodiment. The embodiment does not limit the yarn type or the material of the textiles and the layer number of the textile layers herein, which should depend on the design and requirement of the user.

TABLE 1

| | Double layer | Double layer | Triple layer |
|---|---|---|---|
| | textile | textile | textile |
| Type of | PET | PP | PET |
| longitudinal and | 500d~3000d | 500d~3000d | 500d~3000d |
| latitudinal yarn | | | |

| | |
|---|---|
| Density of | 30~60 thread/in |
| textile | |
| Strength of | ≧500 kgf/5 cm |
| textile | |

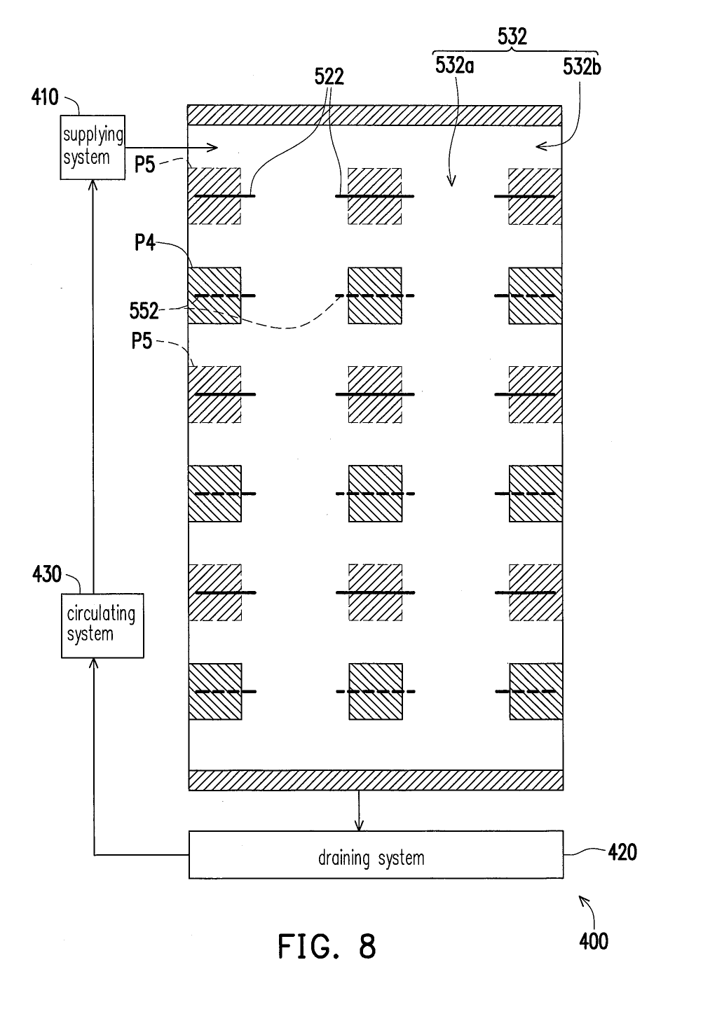

FIG. 8 illustrates a top view of a planting three-dimensional textile according to another embodiment of the present invention. Referring to FIG. 8, the planting apparatus 400 of the present embodiment is one of the applied embodiments of the planting three-dimensional textile 500. The planting apparatus 400 further includes a water inlet system 410 for providing water into the planting channels 532. In detail, the water inlet system 410 can be integrated in the planting channels 532. and is adapted to provide water to the above-mentioned planting fillings 140. Thus, the plants in the planting fillings 140 can absorb the water and grow up. In addition, the textile layers can be made by air-permeable or water-permeable fibers, so when the planting three-dimensional textile 500 is vertically placed, the water located above can flow toward the planting channels 532 located below so as to provide the water to the planting fillings 140 located at other locations. In another embodiment, the water inlet system 410 may provide water by spraying or any other suitable methods.

When the planting three-dimensional textile 500 is vertically placed, the water located above flows toward the lower point, the planting apparatus 400 thus can further include a water outlet system 420, wherein the water outlet system 420 is mainly configured to collect the water passing through the planting channels 532. In another embodiment, for better usage of water resource and preventing water resource from being wasted, the planting apparatus 400 also may include a cycling system 430, wherein the cycling system is mainly for transferring the water collected by the water outlet system into the water inlet system 410, so the water can be repeatedly used. In the present embodiment, the cycling system 430 is, for example, a pumping motor.

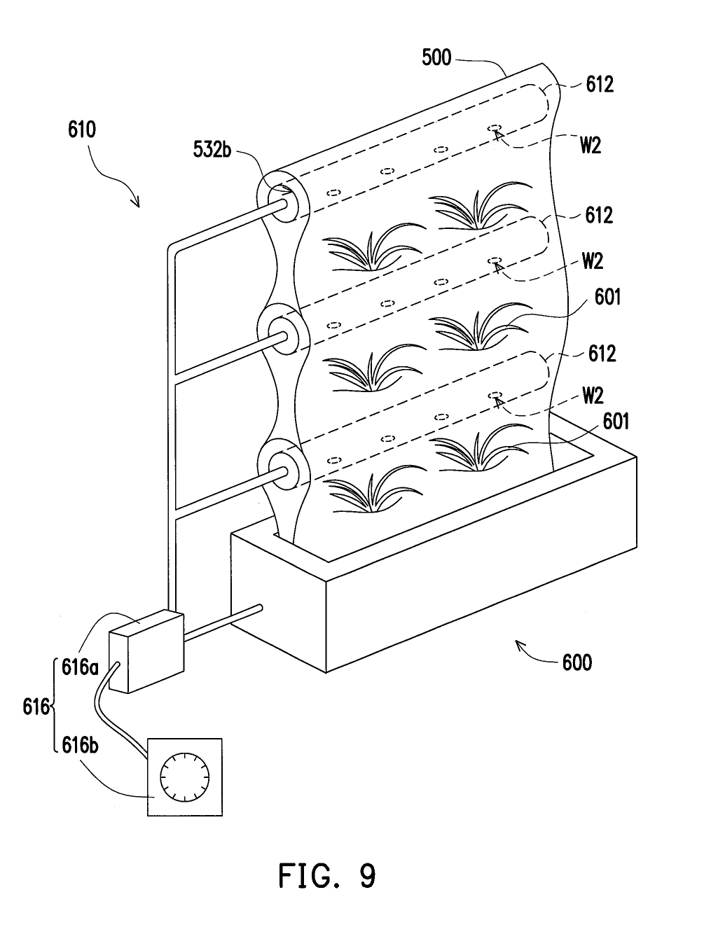

FIG. 9 illustrates a schematic view of a planting three-dimensional textile according to an embodiment of the present invention. Referring to FIG. 9, the planting apparatus 600 of the present embodiment is one of the specific embodiments of the above-mentioned planting three-dimensional textile 400. In the present embodiment, the water inlet system 610 includes at least one rod 612 inserted through the textile layers (a plurality of rods 612 are illustrated herein, when only one rod is disposed, it can be disposed at the top of the planting three-dimensional textile 500, which means the rod is disposed on the outermost planting channels 532b of the planting three-dimensional textile 500), and a plurality of outlet holes W1 on the surface of the rod 612. The rod 612 is disposed in one of the planting channels 532b, which depends on the design concerns of the user. Moreover, the rod 612 can be a hollow rod, and the outlet holes W1 are adapted to be connected to an inner space of the rod 612, such that the water can be provided to the planting channels 532b through the outlet holes W1.

In the present embodiment, the rod 612 can be a steel pipe, an iron pipe, a high-polymer polyvinyl chloride (HPVC) pipe, a polyethylene (PE) plastic pipe, an acrylonitrile-butadiene-styrene (ABS) plastic pipe, a stainless steel pipe, a copper pipe or other suitable pipes, which means it depends on the chosen material of the rod 612. The rod 612 can be the above-mentioned elastic rod or the above-mentioned stiff rod, so the rod 612 can be in curved, straight or any other geometric shape, which depends on the environment the planting apparatus 600 to be disposed on.

For example, if the planting apparatus 600 of the present embodiment is disposed on the outer surface of the building for presenting the green building image, because the shape of the rod 612 can be either curved or straight, the planting apparatus 600 can be matched with the curvature of the outer surface of the building so as to present the green building appearance. In particular, because the planting apparatus can be matched with the curvature of the outer surface of the building, the geometric appearance of the building would not be affected by the planting apparatus 600. In other words, apart from being utilized on the appearance of the building, the planting apparatus 600 can also be used on indoor walls, outdoor shack or any other environments or objects to be planted. Furthermore, the planting apparatus 600 can further include a water proof member (not shown). The water proof member can be disposed on one of the surfaces of the planting three-dimensional textile. In other words, the water proof member is formed by coating or applied other component to provide one side of the planting three-dimensional textile the water-proof function so as to prevent the surface of the building from damage due to moisture.

In the planting apparatus 600, the water from the planting three-dimensional textile 500 can be collected by disposing the bottom of the planting three-dimensional textile 500 in a water collecting tank 620 (as shown in lower part of the figure).

In the present embodiment, the planting three-dimensional textile 600 can also include a flow controller 616 for controlling the amount of water provided to the planting channels 532b, as shown in FIG. 5. In detail, the flow controller 616 may include a motor 616a and a timer 616b, wherein the timer 616a is electronically connected to the motor 616b to control the time of the motor 616a charging and discharging the water. In particular, the motor 616a may be connected to the rod 612 by an external pipe so as to provide water to the planting three-dimensional textile 500 by the rod 612 for the plants 601 on the planting three-dimensional textile 500 to grow. The water from the planting channels or leaking out of the textile is collected to the water collecting tank 620, such that the motor 616a re-injects the water into the rod 612 to perform water cycling.

Moreover, in another not-shown embodiment, the above-mentioned motor 616a, timer 616b, rod 612 may also be integrated and hidden in the planting three-dimensional textile 500 and be controlled by a control unit (not shown). The embodiment does not limit the methods of integrating the above mentioned components herein.

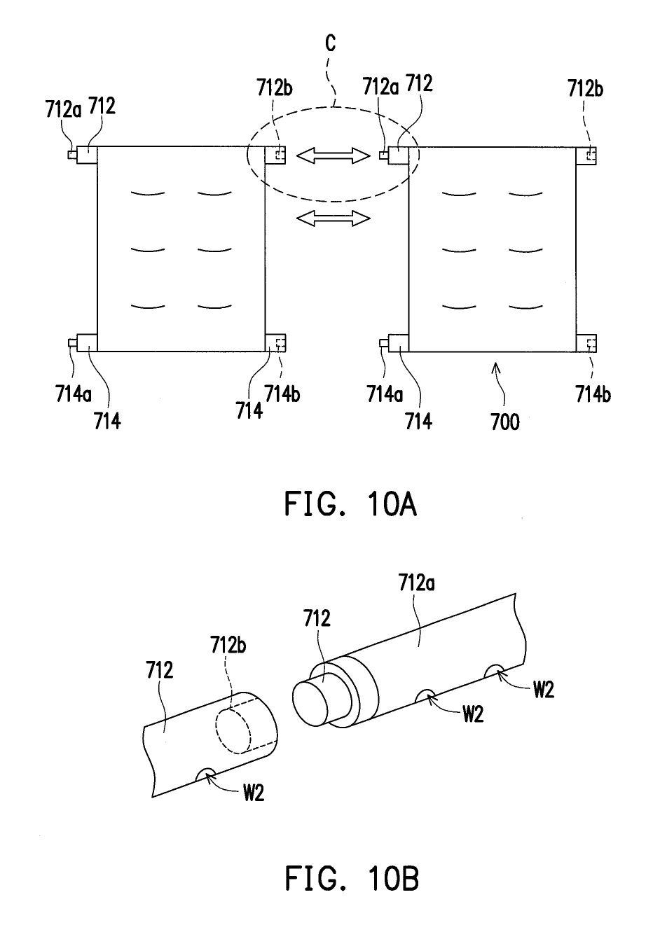

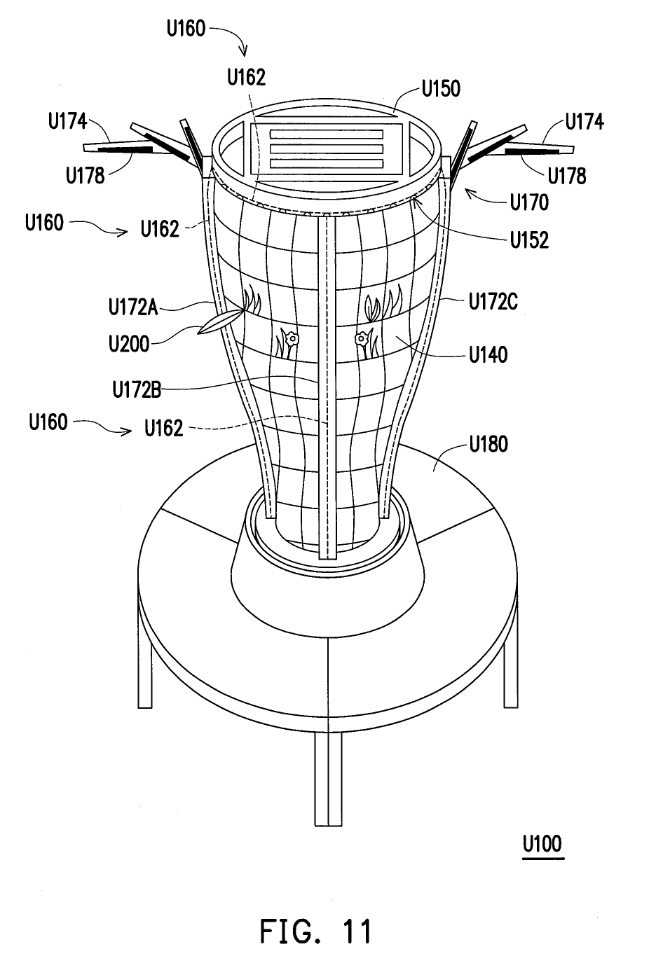

FIG. 10A illustrates a schematic view of two planting three-dimensional textile connected to each other with the connecting member. FIG. 10B illustrates a perspective view of the region C in FIG. 10A. Referring to FIG. 10A and FIG. 10B, in the present embodiment, a first connecting member 712a and a second connecting member 712b are respectively disposed on two opposing ends of the first rod 712 of each planting three-dimensional textile 700, and a third connecting member 714a and a fourth connecting member 714b are respectively disposed on two opposing ends of the second rod 714 of each planting three-dimensional textile 700. Thus, any two planting three-dimensional textile 700 can be connected to each other by connecting first connecting member 712a to the adjoining second connecting member 712b, and connecting the third connecting member 714a to the adjoining fourth connecting member 714b, so as to form the planting three-dimensional textiles assembly as shown in FIG. 10A and FIG. 10B.

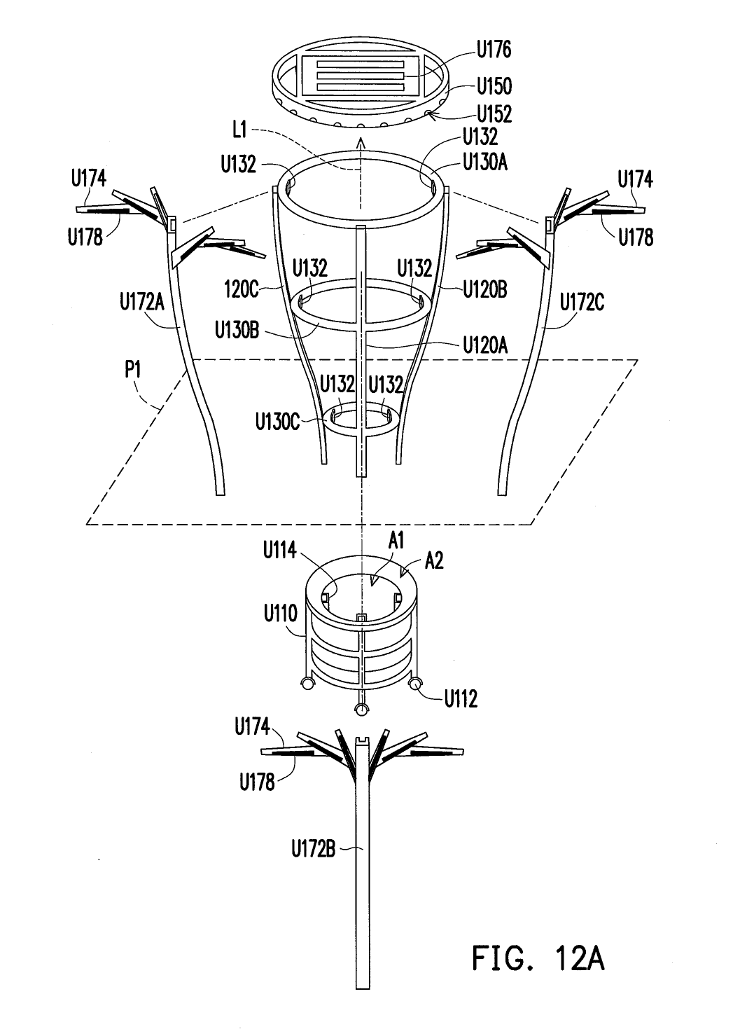

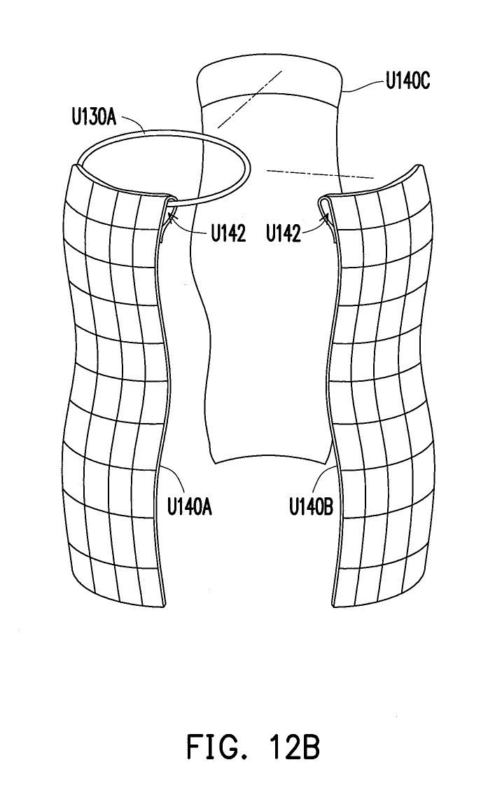

FIG. 11 is a schematic view of a planting apparatus according to one embodiment of the present invention. FIG. 12A and FIG. 12B are exploded views of planting apparatus of FIG. 11, respectively, wherein FIG. 12A mainly illustrates the relationship between the movable tank and the top brackets, and FIG. 12B illustrates the relationship between the horizontal bracket and the planting three-dimensional textile.

In the present embodiment, the movable planting apparatus U100 include a movable tank U110, a plurality of vertical brackets 1120A, U120B and U120C, at least one horizontal bracket U130A, U130B and U130C, a three-dimensional textile U140, a top bracket 1150 and a watering device U160. The movable tank U110 has a water collecting area A1 and a supporting area A2 surrounding the water collecting area A1. The vertical brackets U120A, U120B and U120C stand on the supporting area A2. The horizontal brackets U13A, U130B and U130C connect the vertical brackets U120 so as to from the main structure of the movable planting apparatus U100. The three-dimensional textile U140 is assembled on the horizontal bracket 1130A and covers the vertical brackets U120A, U120B and U120C. The top bracket U150 is assembled on the top of the vertical brackets U120A, U120B and U120C, and the top bracket U150 has a plurality of outlets U152 facing toward the three-dimensional textile U140. The watering device U160 includes a channel U162 which is configured along the vertical brackets U120A, U120B and U120C, and extended to the outlets U152 of the top bracket U150.

For a detailed description of this section, the detail structure of the planting three-dimensional textile U140 can be found in the previous embodiments, therefore no further description is contained herein.

In general, in the present embodiment, the planting three-dimensional textile U140 is suitable for carrying plants U200, and the multi-layer textile structure provides the plants U200 great long-term growing spaces and the living environment which can extend in all directions. The watering device U160 collects the water from the movable tank U110 through the channel U162 and transmits the water to the outlets U152 of the top bracket U150, such that the water can be poured from the top bracket U150, at the same time, with the permeating channels and the permeability of the planting three-dimensional textile U140, the water may permeate through layers and flow to the movable tank U110 and be reused. Thus, the movable planting apparatus U100 may have the independent water supply system so as to save the maintenance labor cost. In addition, with the roller U112 of the movable tank U110, the mobility of the movable tank is thus increased, such that the movable planting apparatus U100 does not need to be repeatedly uninstalled and installed when moved to places, so as to improve the working efficiency. The present invention does not limit the moving structure of the movable tank U110 herein. Any related structures can help moving objects may be adapted to the present invention.

In detail, in the present embodiment, the three horizontal brackets U130A, U130B and U130C are in circular shape and the vertical brackets U120A, U120B and U120C are connected to the horizontal brackets U130 from the outside. In the present embodiment, the vertical brackets U130A, U130B and U130C have a plurality of L-shaped hooks, and the horizontal brackets U130A, U130B and U130C are hung on the hooks correspondingly, such that the center of the horizontal brackets U130A, U130B and U130C are located on the same axis L1, wherein the orthogonal projection area of horizontal brackets U130A, U130B and U130C on a plane PA1 is increased orderly from the bottom to the top (as shown in FIG. 12A, the horizontal brackets from the bottom to the top in order are U130C, U130B and U130A), such that the vertical brackets U120A, U120B and U120C are in curvy profile, and the planting three-dimensional textile U140 covers the vertical brackets U120A, U120B and U120C along the curvy profile and covers the horizontal brackets U130A, U130B and U130C. Thereby, the movable planting apparatus U100 not only has better appearance, also provides water from the top to the bottom, and the water may permeate from the top down to collecting area A1 of the movable tank U110.

Moreover, the planting three-dimensional textile U140 are divided into three pieces of separated curtains U140A, U140B and U140C, wherein each of the curtains U140A, U140B and U140C has a sleeve portion U142 connected to the topmost horizontal brackets U130A (the one closest to the top bracket U150), and covers the vertical brackets U120A, U120B, U120C and the horizontal brackets U130A, U130B and U130C. In the present embodiment, the sleeve portion U142 is formed by folding or rolling up on end of each of the curtains U140A, U140B and U140C, and in other not shown embodiment, the sleeve portion can be made between the textile layers when the curtains U140A, U140B and U140C are woven, or one of the planting channels may be taken as the sleeve portion. Thereby each of the curtains U140A, U140B and U140C can be evenly hung on the horizontal bracket U130A and then the horizontal brackets U130A, U130B, U130C and the vertical brackets U120A, U120B and U120C may be assembled, so as to simplify the assembling. However, the present invention does not limit the disassemble methods of the planting three-dimensional textile U140, the designer can make suitable adjustment according to the requirement of the usage and the related components.

Moreover, the movable planting apparatus U100 further includes an illumination device U170 and the illumination device U170 includes a plurality of trunks U172A, U172B and U174C, a plurality of branches U174, a power system U176 and a plurality of illumination units U178 (herein the branches U174 and the illumination units U178 of the trunks U172B are not shown in FIG. 11). The trunks U172A, U172B and U172C are configured along the corresponding vertical brackets U120A, U120B and U120C, and can be used as the appearance decorations of the vertical brackets U120A, U120B and U120C and the channel U162. The branches U174 are disposed on the top of each of the trunks U172A, U172B and U172 and are extended therefrom. The power system U176 is disposed on the top bracket U150 and the illumination units U178 are respectively embedded in the corresponding branches U174. The illumination units U178 are electronically connected to the power system U176 and emits the light toward the planting three-dimensional textile U140. Thereby, the movable planting apparatus U100 can provide sufficient illumination to the plants U200 on the planting three-dimensional textile U140 by the illumination device U170. Also, the profiles of the trunks U172A, U172B and U172C and the branches U174 improve the appearance of the movable planting apparatus U100.

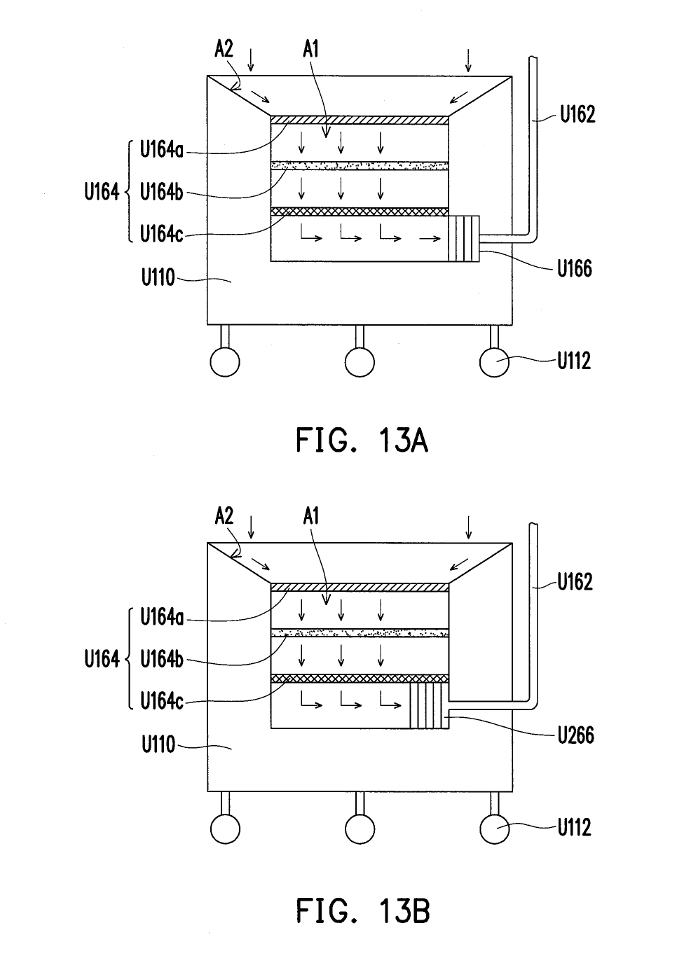

FIG. 13A is a side views showing the movable tank of FIG. 12A. Referring to FIG. 12A and FIG. 13A, in the present embodiment, the movable tank U110 has a plurality of connecting pipes U114 located on the supporting area A2. The connecting pipes U114 are hollow rectangular structures and the vertical brackets U120A, U120B and U120C are jointed with the corresponding connecting pipes U114, such that the above-mentioned components can stand on the supporting area A2. Moreover, the channel U162 may extend along the vertical brackets U120A, U120B and U120C through the connecting pipes U114, so as to be hidden on the inner side of the vertical brackets U120A, U120B and U120C.

Furthermore, the water collecting area A1 is a concave structure, and the supporting area A2 of the movable tank U110 is a tilted surface. The tilted surface is configured to support and collect the water permeated from the planting three-dimensional textile U140 such that the water can be the source of the recycling water. In addition, in order to keep the source of the recycling water clear, the watering device U160 further includes a filtering units U164, disposed on the water collecting area A1 of the movable tank U110. In the present embodiment, the filtering unit U164 includes a filtering layer U164a, a filtering cotton layer U164b and a activate carbon layer U164C, which are disposed by layer along the tilted surface toward the bottom of the water collecting area A1 so as to filter the recycling water.

On the other hand, the watering device U160 further includes a pump U166 which is, for example, an external pump, and is disposed on the outer side of the water collecting area A1 (which is the outer side of the concave structure) and is connected between the channel U162 and the water collecting area A1. Thereby, the filtered water can be pressured to transmit to the channel U162 by the pump U166, so as to be poured from the outlets U152 of the top bracket U150 to water the planting three-dimensional textile. However, the present invention does not limit the type of the pump herein. FIG. 13B is a side view of a movable tank of a movable planting apparatus according to another embodiment of the invention. The difference between the present embodiment and the previous embodiment is that the pump U266 of the present embodiment is a sinking pump and is disposed within the concave structure (which means inside the water collecting area A1).

Referring back to FIG. 11, in the present embodiment, the movable planting apparatus U100 further includes a supporting base U180, and the supporting base U180 can be symmetrically divided as the vertical brackets U120A, U120B and U120C, and the three curtains U140A, U140B and U140C of the planting three-dimensional textile U140 are, and is assembled to the outside of the vertical brackets U120A, U120B and U120C and the movable tank U110. The supporting base U180 not only can cover the movable tank U110 and part of the vertical brackets U120A, U120B and U120C or the horizontal brackets U130A, U130B and U130C as the appearance decoration, but also can provide a seat feature so the movable planting apparatus U100 can be multi-functional. The structure formation and the profile of the supporting base U180 are not limited herein. The designer can adding any extra functional structures on the movable planting apparatus U100 according to the design requirement.

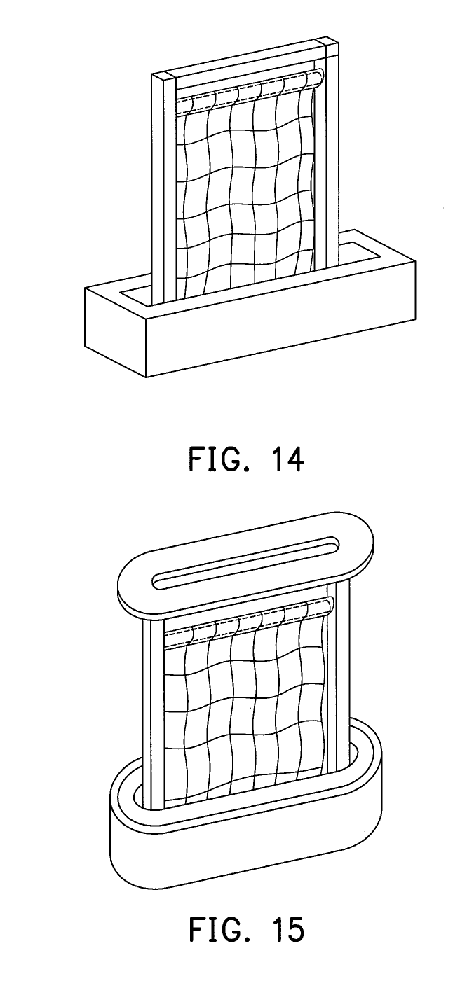

In addition, FIG. 14 to FIG. 16 are schematic views of planting apparatuses according to other embodiments of the present invention, wherein the planting apparatuses in FIG. 14 to FIG. 16 are the similar embodiments derived from the above-mentioned embodiments.

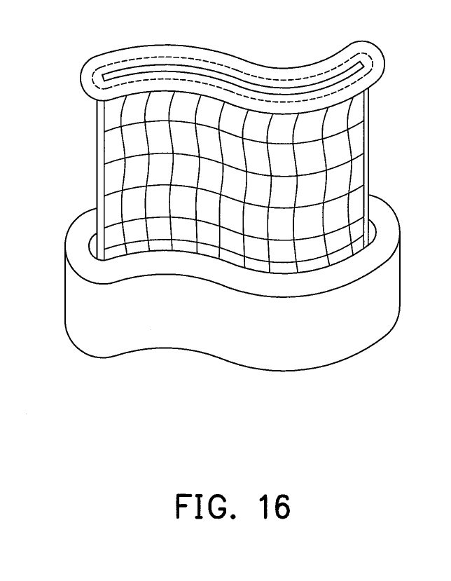

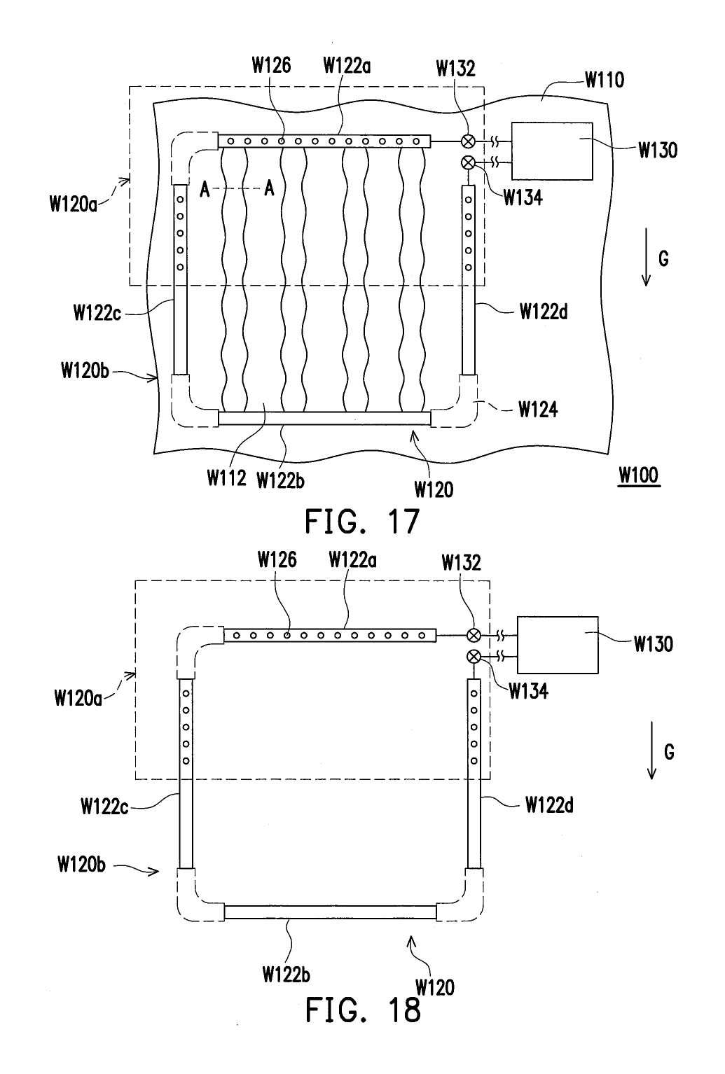

FIG. 17 is a schematic view of a planting apparatus according to another embodiment of the present invention. FIG. 18 is a schematic view of the water cycling of the planting apparatus in FIG. 17. In the present embodiment, the planting apparatus W100 includes a three-dimensional textile W110, a pipe assembly W120 and a cycling water supply unit W130, wherein the three-dimensional textile are omitted in FIG. 18 so as to show the water supply method of the planting apparatus clearly.

In the present embodiment, the three-dimensional textile W110 has a plurality of planting channels W112 which are separated from each other so as to provide the plants growing space. Similarly, the detail structure of the planting three-dimensional textile of the present embodiment can be found in the previous embodiments, therefore no further description is contained herein.

In the present embodiment, the planting channels W112 are parallel to each other and are configured along a gravity direction G, and the pipe assembly 120 are configured along the edge of the planting three-dimensional textile W110. The pipe assembly 120 surrounds and connecting the planting channels W112. For example, the cycling water supply unit W130 is constructed of a pump and a water storage tank (not shown), and has an outlet valve W132 and an inlet valve W134 which are respectively connected to the pipe assembly W120, so as to form a cycling water supply path with the pipe assembly W120 surrounding the planting three-dimensional textile W110. In other words, the pump transmits the water from the water storage tank to the pipe assembly W120 through the outlet valve W132. The pipe assembly W120 surrounds the planting three-dimensional textile W110 such that the water can flow to the planting three-dimensional textile W110 for watering the plants. After that, the rest of the water flow back to the cycling water supply unit W130 along the pipe assembly via the inlet valve W134 so as to recycling the water.

It is noted that the pipe assembly W120 of the present embodiment is embedded in the planting three-dimensional textile W110. That is to say, the pipe assembly W120 actually can not be seen on the planting three-dimensional textile W110 of the planting apparatus W100 in FIG. 17. To be specific, the pipe assembly W120 of the present embodiment are woven with the planting three-dimensional textile W110 by sewing. In other embodiment, the pipe assembly W120 can be jointed with the planting three-dimensional textile W110 by thread-less methods such as RF fusing, ultrasonic fusing, thermal compression fusing, etc., so as to improve the appearance of the planting apparatus W100.

In the present embodiment, the pipe assembly W120 includes a plurality of pipes W122a, W122b, W122c, W122d and a plurality of quick couplers W124, wherein each of the quick couplers W124 can be detachably connected between any two of the connecting pipes W122a, W122b, W122c, W122d (additionally, the quick couplers Q124 can also be connected between the pipes W122a, W122b, W122c, W122d and the cycling water supply unit W130). In other embodiment, the amount of the pipes W122a, W122b, W122c, W122d and the quick couplers W124 can be any suitable amount. Besides, the quick couplers W124 are L-shaped pipe couplers. In other embodiments, the quick couplers W124 can be curvy-tripod pipe couplers so as to connecting three pipes at the same time, which means the pipes not only can be disposed on the outer edge of the planting three-dimensional textile but also can be disposed between the planting channels. The present invention does not limit the amount and the shape of the quick couplers herein. Thereby, by using the quick couplers W124 to speed up the assembling/disassembling of the pipes W122a, W122b, W122c, W122d, the planting apparatus W100 can be faster and easier to be assembled and disassembled when in use or in maintenance.

Based on the above, the pipe assembly of the present invention is easy to be assembled and disassembled, such that the pipe assembly can be applied to the planting three-dimensional textile as a single modular structure. Thus, the modular planting apparatus can be assembled freely according to the actual need and the requirement of the surrounding environment so as to improve the practicality and the mobility of the planting apparatus.

In detail, the pipe assembly W120 is disposed along the gravity direction G and divided into a water supply area W120a and a pipe full area W120b. The water supply area W120a is located above the pipe full area W120b, and a least a part of the pipes W122 located within the water supply area W120a and has a plurality of water outlets W126. To be more specific, the pipe assembly W120 of the present embodiment includes the pipes W122a, W122b horizontally disposed (the pipe W122a are located above the pipe W122b), and the pipes W122c, W122d vertically disposed (which means disposed along the gravity direction G), wherein the water outlets W126 are disposed on the pipes W122a, and part of the pipes W122c, W122d (as shown in the upper portion of the figure), and there is no water outlet disposed on the pipe W122b. Thus, the pipe W122a and part of the pipes W122c, W122d form the water supply area W120a, and the region without the water outlets W126 of the pipes W122c, W122s forms the pipe full area. Moreover, the water outlets W126 of the pipe W122c, W122d of the present embodiment are not connected with the planting channels W112. Thus, part of the water flows out from the water outlets W126 of the pipes W122c, W122d and permeates down to planting channels W112. With the disposition, the cycling water supply unit W130 provides water into the pipes W122a, W122b, W122c, W122d in order, so that the water flows along the cycling water supply path. In the present embodiment, part of water outlets W126 of the pipes W122a are aligned with the planting channels W112. Therefore, part of the water flows to the planting channels W112 through the water outlets W126 of the pipes W122a. In other embodiment, part of water outlets W126 of the pipe W122a are not aligned with the planting channels W112.

Thereby, part of the water flows out from the water outlets W126 of the pipes W122a, W122c and W122d, and part of the water gradually flows to the pipe full area W120b along the gravity direction G. In the present embodiments, non of the water outlets W126 is disposed on the pipe full area W120b, so the pipe full area W120b can maintain the pipe-full state when the water is provided, such that the air in the pipe W122b of the pipe full area W120b can be reduced. Therefore, with the water supply area W120a disposed corresponding to the pipe full area W120b, the water supply amount can be effectively in control, so as to avoid that the amount of water flowing to the planting three-dimensional textile W110 is uneven. The diameters and the amount of the water outlets W126 and the gap between the water outlets W126 are not limited herein. The designer can make suitable modifications according to the disposition of the pipe assembly in the planting three-dimensional textile W110 and the water requirement of the plants.

Referring to FIG. 17, FIG. 18 and the above-mentioned embodiment of FIG. 6, the pipe assembly W120 of the present embodiment is disposed in the planting three-dimensional textile W110 such that the cycling water supply unit W130 can transmit water through the pipe assembly into the planting channels so the water can flow to everywhere through the planting channels and, meanwhile, permeate downward by layers due to the gravity.

Furthermore, the planting apparatus W100 further includes a water proof member (not shown). The water proof member can be disposed on one of the surfaces of the planting three-dimensional textile. In other words, the water proof member is formed by coating or applied other component to provide one side of the planting three-dimensional textile W110 the water-proof function.

When the planting apparatus W100 is disposed on another component, for example, a wall (not shown), the planting apparatus W100 may prevent the surface of the wall from damage or moisture.

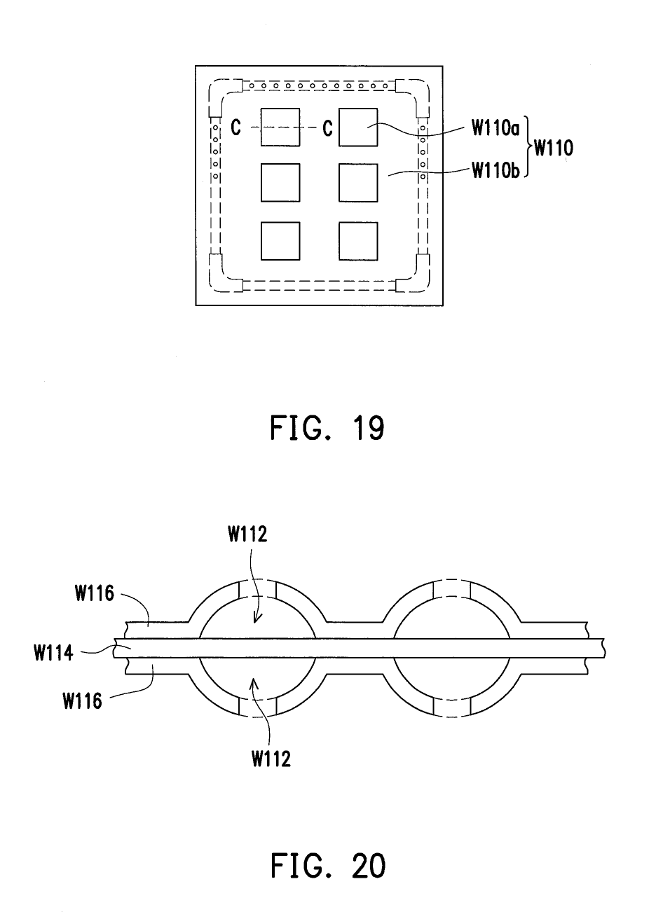

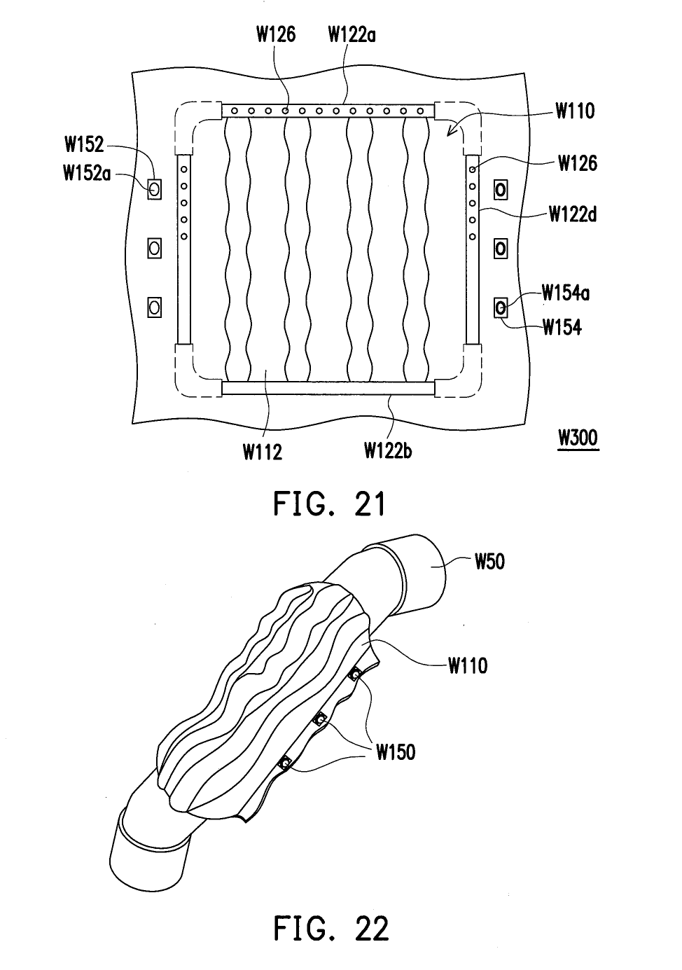

FIG. 19 is a schematic view of a planting apparatus according to another embodiment of the present invention. FIG. 20 is a cross-sectional view of the planting three-dimensional textile taken along line C-C in FIG. 19. Referring to FIG. 19 and FIG. 20, the planting three-dimensional textile W110 includes a plurality of textile bodies W110a, W110b connected to each other. It is noted that, the shape and the function of the planting three-dimensional textile W110 shown in FIG. 19 are the same as or similar to the shape and the function of the planting three-dimensional textile of the plating apparatus in the first embodiment mentioned above. For a detailed content and design can be found in the description of FIG. 17 and FIG. 18, therefore no further description is contained herein.

In detail, each of the textile bodies W110a, W110b are formed by a plurality of textile layers partially connected and covered with each other. The difference are that each of the textile bodies W110a, W110b has different surface area, and the textile body W110a with smaller surface area is connected to the textile body W110b with greater surface area so as to form a pocket structure. In other words, the planting three-dimensional textile W110 located in the pocket structure area forms the planting channels W112 corresponding to each other. In another embodiment, when the planting channels of each textile bodies W110a, W110b are interlaced woven, and the pocket structure are presented as the structure shown in FIG. 7B. Thereby, the planting three-dimensional textile W110 may be arbitrarily arranged according to the demands of the user.

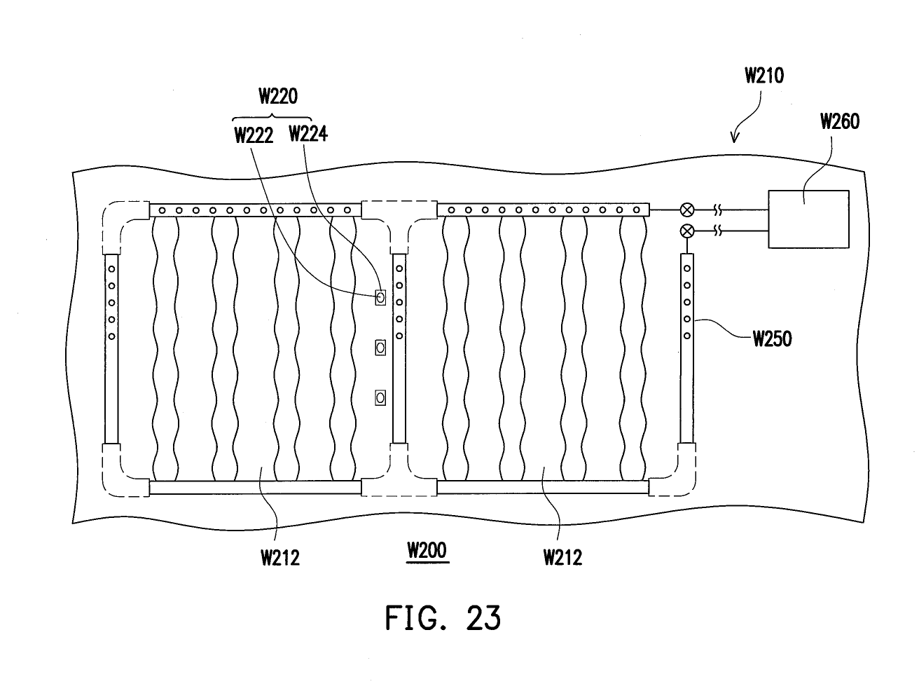

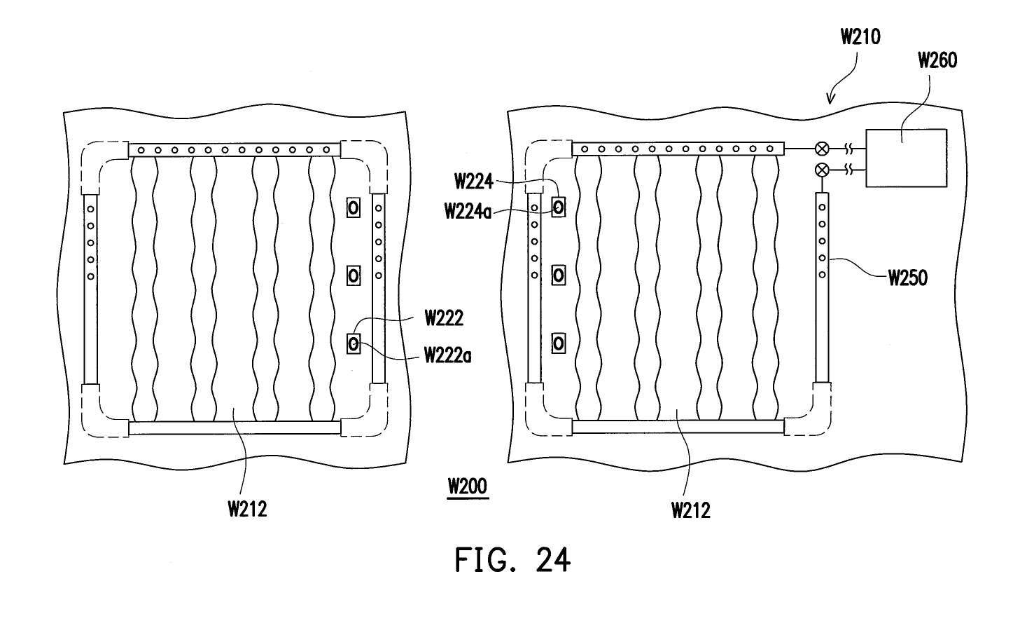

FIG. 21 is a schematic view of a planting apparatus according to another embodiment of the present invention. FIG. 22 is a schematic perspective view of the planting apparatus of FIG. 21. Referring to FIG. 21 and FIG. 22, with the flexibility of the planting three-dimensional textile W110, the planting three-dimensional textile W110 is suitable for covering a surrounding surface of the structure W50, such as the water pipe shown in the present embodiment, or any other structure adapted to be disposed on the planting apparatus, such that the planting channels W112 and the pipe assembly W120 are leaned against part of the structure W50, wherein the pipe assembly W120 also has flexibility and can be covered on the structure W50 along with the planting three-dimensional textile W110.

In detail, the planting apparatus W300 of the present embodiment further includes a connecting member W150. The connecting member W150 is configured along the edge of the planting three-dimensional textile W110. The connecting member W150 includes a first lock unit W152 and a second lock unit W154. The first lock unit W152 has a hook W152a and the second lock unit W154 has a groove W154a, such that the hook W152a is locked into the groove W154a (in other not shown embodiment, the connecting means can be the lock units which the profiles thereof corresponds to each other). When the planting three-dimensional textile W110 covers the structure W50, the hook W152a is detachably locked into the corresponding groove W154a to connect two opposing sides of the planting three-dimensional textile W110, such that the planting three-dimensional textile W110 is fixed to the structure W50. However, the present invention does not limit the amount and the modular formation of the planting three-dimensional textile herein.

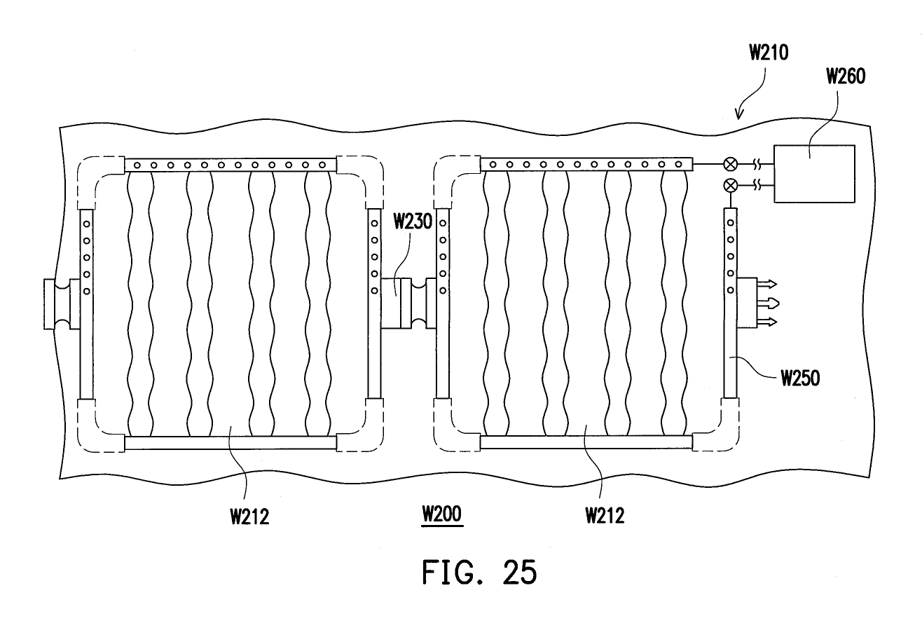

FIG. 23 and FIG. 24 are schematic assembled views of a planting apparatus according to another embodiment of the present invention. Referring to FIG. 23 and FIG. 24, in the present embodiment, the planting apparatus W200 further provides two planting three-dimensional textile W210, a plurality of connecting members W220, a pipe assembly W250 and a cycling water supply unit W260. Each of the connecting members W220 connects the joint between each of the three-dimensional textiles 210 for sealing the three-dimensional textiles W210. The pipe assembly W250 is configured along the edge of the three-dimensional textiles W210, and the pipe assembly W250 surrounds the planting channels W212. The cycling water supply unit W260 is connected to the pipe assembly W250.

The similarity between the present embodiment and the previous embodiment is that the connecting member W220 of the present embodiment includes a first lock unit W222 and a second lock unit W224. The first lock unit W222 has a hook W222a, and the second lock unit W224 has a groove W224a, wherein the hook W222a is detachably locked into the corresponding groove W224a. However, the difference is that the first lock unit W222 and the second lock unit W224 of the present embodiment are belonged to different planting three-dimensional textile W210 and E220, so as to connect the planting three-dimensional textile W210.

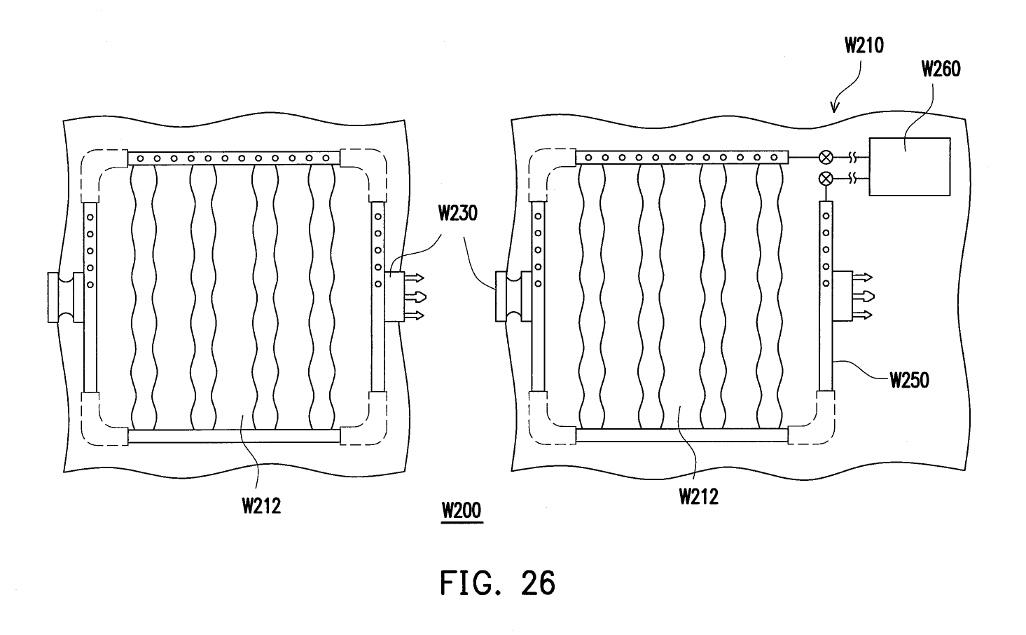

FIG. 25 and FIG. 26 are schematic assembled views of a planting apparatus according to another embodiment of the present invention. The difference between the present embodiment and the previous embodiment is the connecting member W230 of the present embodiment is locked by tenon. In other words, the connecting members W220 (as shown in FIG. 23 and FIG. 24), W230 (as shown in FIG. 25 and FIG. 26) of the present invention includes a male lock member and a female lock member connected to each other wherein the shapes of the lock members are corresponding to each other. For example, clamp, lock ring, row buttons, button, tenon, double-D buttons, etc.

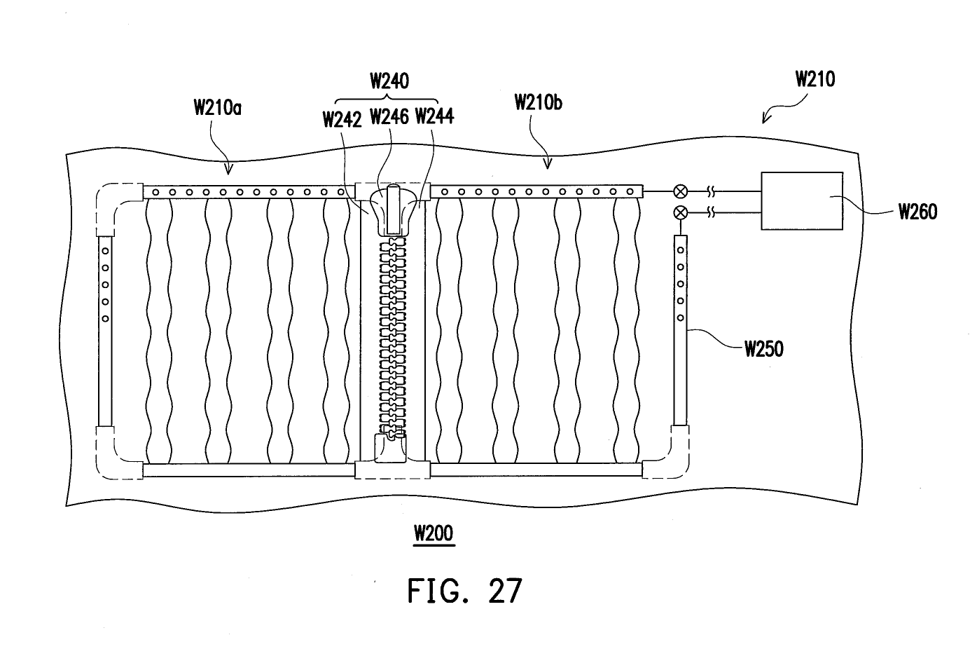

FIG. 27 is a schematic view of a planting apparatus according to another embodiment of the present invention. Referring to FIG. 27, the similarity between the present embodiment and the previous embodiment is that, in the present embodiment, the connecting member W240 of planting apparatus W200 includes a first junction unit W242, a second junction unit W244 and a third junction unit W246. The first junction unit W242 is disposed correspondingly to the planting three-dimensional textile W210a, and the second junction unit W244 is disposed correspondingly to the planting three-dimensional textile W210b. The first junction unit W242 and the second junction unit W244 are jointed together by the third junction unit W246, such that the planting three-dimensional textiles W210a, W210b are connected to each other. A zipper is illustrated as an example herein, however, similar three-piece jointing structures such as screw, latch, etc. can be applied to the present embodiment.

In summary, in the above-mentioned embodiments, the second textile layer is only connected to the connecting blocks so as to define a plurality of planting channels between the first textile layer and the second textile layer, wherein the second textile layer has a plurality of openings, therefore, the planting three-dimensional textile can provide the plants with great long-term growing space and the living environment which can extend in all four directions.

Moreover, each of the connecting blocks in stripe shapes has a plurality of cutting apertures passing through the first textile layer and the second textile layer. Thereby, the planting three-dimensional textile provides the plants with great growing space and extending space. Moreover, the planting three-dimensional textile can be expanded by the planting channels. In addition, the planting three-dimensional textile can be expanded and compressed so as to have a flexible usage area.

Furthermore, the planting three-dimensional textile can be disposed on a movable structure with independent watering device and illumination device. Therefore, the movable planting device not only has the mobility, but also can reduce the maintenance labor cost for displaying or nurturing, the efficiency thus is improved.

Also, the connecting member makes the pipe assembly easy to be assembled and disassembled, such that the pipe assembly can be applied to the planting three-dimensional textile as a single modular structure. Thus, the modular planting apparatus can be assembled freely according to the actual need and the requirement of the surrounding environment so as to improve the practicality and the mobility of the planting apparatus.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A planting three-dimensional textile, comprising:
a first textile layer, having a first surface and a second surface, and the first textile layer having a plurality of first connecting blocks which are separated from each other and arranged in array; and
a second textile layer, covering the first surface, and the second textile layer only connected to the first connecting blocks so as to define a plurality of first planting channels separated form each other between the first textile layer and the second textile layer, and the second textile layer having a plurality of first openings.

2. The planting three-dimensional textile as claimed in claim 1, wherein the first connecting blocks are in strip shapes.

3. The planting three-dimensional textile as claimed in claim 2, wherein each of the first connecting blocks has a plurality of cutting apertures which are separated from each other and paralleled to the first connecting blocks, and the cutting apertures pass through the first textile layer and the second textile layer.

4. The planting three-dimensional textile as claimed in claim 3, wherein the first planting channels are not connected to each other through the cutting apertures.

5. The planting three dimensional textile as claimed in claim 3, wherein an extending direction of each of the cutting apertures is parallel to a first direction, and when the first textile layer and the second textile layer are subjected to an outer force perpendicular to the first direction, the width of each cutting aperture is magnified and the first planting channels are presented in mesh pattern.

6. The planting three-dimensional textile as claimed in claim 2, wherein the length of each cutting aperture is L, the gap between any two adjoining cutting apertures located within the same first connecting block is P, and L>P.

7. The planting three-dimensional textile as claimed in claim 2, wherein the lengths of part of the cutting apertures are L1, the lengths of part of the cutting apertures are L2, and L1≠L2.

8. The planting three-dimensional textile as claimed in claim 2, wherein the second textile layer are connected to the first connecting blocks by yarn interlacing method, so the second textile layer and the first connecting blocks are integrally formed.

9. The planting three-dimensional textile as claimed in claim 1, wherein the material of the first textile layer is the same as the material of the second textile layer.

10. The planting three-dimensional textile as claimed in claim 1, wherein the material of the first textile layer is different from the material of the second textile layer.

11. The planting three-dimensional textile as claimed in claim 1, wherein the material of the first textile layer includes polyester, polypropylene, polyolefin polymer, nylon, rayon or synthetic cotton fibers.

12. The planting three-dimensional textile as claimed in claim 1, wherein the material of the second textile layer includes polyester, polypropylene, polyolefin polymer, nylon, rayon or synthetic cotton fibers.

13. The planting three-dimensional textile as claimed in claim 1, wherein the first planting channels includes a plurality of vertical planting channels and a plurality of horizontal planting channels, and the vertical planting channels and the horizontal planting channels are interlaced with and connected to each other.

14. The planting three-dimensional textile as claimed in claim 1, wherein the first planting channels are meshed channels.

15. The three-dimensional memory structure as claimed in claim 1, further comprising:
A plurality of first planting fillings, filled in the first planting channels, wherein the first openings expose part of the first planting fillings.

16. The planting three-dimensional textile as claimed in claim 15, wherein the first planting fillings include natural fibers, synthetic fibers, semi-synthetic fibers, paper pulp, foam, soil-free planting substrate or planting soil.

17. The three-dimensional memory structure as claimed in claim 1, further comprising:
a third textile layer, wherein the first textile layer has a plurality of second connecting blocks which are separated from each other and arranged in array, the third textile layer covers the second surface of the first textile layer, the third textile layer is only connected to the second connecting blocks so as to define a plurality of second planting channels connected to each other between the first textile layer and the third textile layer, and the third textile layer has a plurality of second openings.

18. The planting three-dimensional textile as claimed in claim 17, wherein the first connecting blocks are not overlapped with the second connecting blocks.

19. The three-dimensional memory structure as claimed in claim 17, further comprising:
A plurality of second planting fillings, filled in the second planting channels, wherein the second openings expose part of the second planting fillings.

20. The planting three-dimensional textile as claimed in claim 19, wherein second planting fillings include natural fibers, synthetic fibers, semi-synthetic fibers, paper pulp, foam, soil-free planting substrate or planting soil.

21. The three-dimensional memory structure as claimed in claim 1, further comprising:
a water inlet system, for providing water into the first planting channels.

22. The planting three-dimensional textile as claimed in claim 21, wherein the water inlet system comprises a first rod and a plurality of first outlet holes located on the surface of the first rod, the first rod is disposed in one of the first planting channels, and the water inlet system is adapted to provide water into the first planting channels through the first outlet holes.

23. The planting three-dimensional textile as claimed in claim 22, wherein the first rod is a hollow rod, and the first outlet holes are connected to an inner space of the first rod.

24. The planting three-dimensional textile as claimed in claim 22, wherein the first rod includes an elastic rod or a stiff rod.

25. The planting three-dimensional textile as claimed in claim 22, wherein the first rod is in curved shape.

26. The planting three-dimensional textile as claimed in claim 22, wherein the water inlet system further comprises a first connecting member and a second connecting member, the first connecting member and the second connecting member are respectively disposed on two opposing ends of the first rod.

27. The planting three-dimensional textile as claimed in claim 21, further comprising a flow controller, connected to the water inlet system and controlling the amount of the water provided to the first planting channels.

28. The planting three-dimensional textile as claimed in claim 21, wherein the flow controller comprises a motor and a timer, wherein the timer is electronically connected to the motor to control the time of the motor charging and discharging the water.

29. The planting three-dimensional textile as claimed in claim 1, further comprising a water outlet system to collect the water flowing pass the first planting channels.

30. A planting apparatus, comprising:
a movable tank, having a water collecting area and a supporting area surrounding the water collecting area;
a plurality of vertical brackets, standing on the supporting area;
at least one horizontal bracket, connecting the vertical brackets;
at least one three-dimensional textile, assembled on the horizontal bracket and covering the vertical brackets, and the three-dimensional textile suitable for carrying plants;
a top bracket, assembled on the top of the vertical brackets, the top bracket having a plurality of outlets facing toward the three-dimensional textile; and
a watering device, having at least one channel, the channel configured along at least one of the vertical brackets and extending to at least one of the outlets of the top bracket.

31. The planting apparatus as claimed in claim 30, wherein the vertical brackets, the horizontal brackets and the top bracket form a plate structure standing on the movable tank.

32. The planting apparatus as claimed in claim 30, wherein the vertical brackets and the horizontal brackets form a plate structure standing on the movable tank, and the top bracket is in ring shape so as to joint the top of the vertical brackets.

33. The planting apparatus as claimed in claim 30, wherein the vertical brackets and the horizontal brackets form a wavy structure standing on the movable tank.

34. The planting apparatus as claimed in claim 30, wherein the at least one horizontal bracket includes a plurality of horizontal brackets, the top bracket and the horizontal brackets are in circular shape and the vertical brackets are connected to the horizontal brackets and the top bracket from the outside.

35. The planting apparatus as claimed in claim 34, wherein each of the vertical brackets has a plurality of hooks, the horizontal brackets are hung on the hooks.

36. The planting apparatus as claimed in claim 34, further including the top bracket and the horizontal brackets in circular shape, and the center of the top bracket and the center of the horizontal brackets are located on the same axis.

37. The planting apparatus as claimed in claim 34, wherein the three-dimensional textile has a plurality of separated curtains, each of the curtains is hung on one of the horizontal brackets.

38. The planting apparatus as claimed in claim 37, wherein the horizontal bracket hanging the curtains is adjacent to the top brackets.

39. The planting apparatus as claimed in claim 30, further comprising:
a illumination device, comprising:
a power system, disposed on the top bracket; and
a plurality of illumination units, electronically connected to the power system, the illumination units extending from the top bracket and facing the three-dimensional textile.

40. The planting apparatus as claimed in claim 39, further comprising:
a plurality of trunks, disposed along the vertical brackets; and
a plurality of branches, disposed on the top of the trunks, the illumination units are respectively embedded within the branches.

41. The planting apparatus as claimed in claim 30, wherein the movable tank has a plurality of connecting pipes, the vertical brackets joint the corresponding connecting pipes.

42. The planting apparatus as claimed in claim 30, wherein the water collecting area of the movable tank is a concave structure, and the supporting area of the movable tank is a tilted surface.

43. The planting apparatus as claimed in claim 42, wherein the water device further has a filtering unit, disposed in the water collecting area of the movable tank, the filtering unit has a filtering net layer, a filtering cotton layer, an activated carbon layer, which are disposed by layer along the tilted surface toward the bottom of the water collecting area.

44. The planting apparatus as claimed in claim 42, further comprising:
a pump, connected between the water collecting area of the movable tank and the channel.

45. The planting apparatus as claimed in claim 44, wherein the pump is an external pump disposed on an outer side of the concave structure.

46. The planting apparatus as claimed in claim 44, wherein the pump is a sinking pump disposed in the concave structure.

47. A planting apparatus, comprising:
a three-dimensional textile, having a plurality of planting channels;
a pipe assembly, disposed along the edge of the three-dimensional textile, the pipe assembly surrounding the planting channels; and
a cycling water-supply unit, connected to the pipe assembly for providing and transmitting the water to the planting channels through the pipe assembly.

48. The planting apparatus as claimed in claim 47, wherein the pipe assembly is connected to the planting channels.

49. The planting apparatus as claimed in claim 47, wherein the three-dimensional textile comprises a first textile layer and a second textile layer covering each other, and the first textile layer and the second textile layer are partially connected to each other so as to define the planting channels therebetween, and the pipe assembly is disposed between the first textile layer and the second textile layer.

50. The planting apparatus as claimed in claim 49, further comprising:
a water proof member, disposed on the surface of the first textile layer away from the second textile layer, or disposed on the surface of the second textile layer away from the first textile layer.

51. The planting apparatus as claimed in claim 49, wherein the three-dimensional textile comprises a plurality of textile bodies connected to each other, and each of the textile bodies has the first textile layer and the second textile layer.

52. The planting apparatus as claimed in claim 51, wherein the textile bodies have different surface areas, and the textile body with smaller surface area is connected to the textile body with greater surface area so as to form a pocket structure.

53. The planting apparatus as claimed in claim 47, wherein the three-dimensional textile comprises a plurality of textile bodies connected to each other, each of the textile bodies is a single textile layer, the textile bodies have different surface areas, and the textile body with smaller surface area is connected to the textile body with greater surface area so as to form a pocket structure.

54. The planting apparatus as claimed in claim 47, wherein the pipe assembly comprises a plurality of pipes and a plurality of quick couplers, each of the quick coupler is detachably connected between any two connecting pipes.

55. The planting apparatus as claimed in claim 54, wherein the pipe assembly is disposed along the gravity direction and divided into a water supply area and a pipe full area, the water supply area is located above the pipe full area, and a least a part of the pipes located within the water supply area has a plurality of water outlets.

56. The planting apparatus as claimed in claim 47, wherein the three-dimensional textile is adapted to cover a body such that the planting channels and the pipe assembly lean against at least part of the body.

57. The planting apparatus as claimed in claim 56, further comprising:
a connecting member, disposed on the three-dimensional textile, wherein when the three-dimensional textile covers the body, the connecting member connects two opposing sides of the three-dimensional textile such that the three-dimensional textile is fixed onto the body.

58. A planting apparatus, comprising:
a plurality of three-dimensional textiles, connected to each other and having a plurality of planting channels;
a plurality of connecting members, connecting the joints between the three-dimensional textiles for sealing the three-dimensional textiles.
a pipe assembly, disposed along the edge of the three-dimensional textiles, the pipe assembly surrounding the planting channels; and
a cycling water-supply unit, connected to the pipe assembly for providing and transmitting the water to the planting channels through the pipe assembly.

59. The planting apparatus as claimed in claim 58, wherein the pipe assembly is connected to the planting channels.

60. The planting apparatus as claimed in claim 58, wherein each of the three-dimensional textiles comprises a first textile layer and a second textile layer covering each other, and the first textile layer and the second textile layer are partially connected to each other so as to define the planting channels therebetween, and the pipe assembly is disposed between the first textile layer and the second textile layer.

61. The planting apparatus as claimed in claim 60, further comprising:
a water proof member, disposed on the surface of each first textile layer away from the corresponding second textile layer, or disposed on the surface of each second textile layer away from the corresponding first textile layer.

62. The planting apparatus as claimed in claim 61, wherein the three-dimensional textiles comprise a plurality of textile bodies connected to each other, and each of the textile bodies has the first textile layer and the second textile layer.

63. The planting apparatus as claimed in claim 62, wherein the textile bodies have different surface areas, and the textile body with smaller surface area is connected to the textile body with greater surface area so as to form a pocket structure.

64. The planting apparatus as claimed in claim 63, wherein the three-dimensional textiles comprise a plurality of textile bodies connected to each other, each of the textile bodies is a single textile layer, the textile bodies have different surface areas, and the textile body with smaller surface area is connected to the textile body with greater surface area so as to form a pocket structure.

65. The planting apparatus as claimed in claim 58, wherein the pipe assembly comprises a plurality of pipes and a plurality of quick couplers, each of the quick coupler is detachably connected between any two connecting pipes.

66. The planting apparatus as claimed in claim 65, wherein the pipe assembly is disposed along the gravity direction and divided into a water supply area and a pipe full area, the water supply area is located above the pipe full area, and a least a part of the pipes located within the water supply area has a plurality of water outlets.

67. The planting apparatus as claimed in claim 58, wherein each of the connecting members comprises a first lock unit and a second lock unit, wherein the first lock unit and the second lock unit are respectively dispose on the closely connected three-dimensional textiles and correspond to each other.

68. The planting apparatus as claimed in claim 58, wherein each of the connecting members comprises a first junction unit, a second junction unit and a third junction unit, the first junction unit and the second junction unit are respectively disposed on the corresponding three-dimensional textiles, the third junction unit joints the first junction unit and the second junction unit together so as to connect the three-dimensional textiles.
